(19) United States
(12) Patent Application Publication
(10) Pub. No.: US 2007/0033048 A1
(43) Pub. Date: Feb. 8, 2007

(54) Method of producing personalized posters, calendars, and the like which contain copyrighted subject matter

(76) Inventors: Barry D. Pollard, Chicago, IL (US); Jeff Chardell, Deerfield, IL (US); Jon Kozuch, Chicago, IL (US); James Royalty, Chicago, IL (US); David Larson, Chicago, IL (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/298,383

(22) Filed: Dec. 9, 2005

Related U.S. Application Data
(60) Provisional application No. 60/635,699, filed on Dec. 13, 2004.

(51) Int. Cl. G10L 13/08

(52) U.S. Cl. 704/260

(57) ABSTRACT

A method of producing personalized posters, calendars, and the like (“printed products”) which enables consumers to select from a store of stored images or other digital assets, which may include copyrighted subject matter. The system allows a user to select a stored digital asset for a printed product and incorporate a personalized text message therewith. In order to prevent offensive textual messages, the system includes a text filter for blocking personalized textual material that may be offensive. In an optional embodiment, the system may also include a royalty tracking engine for automatically tracking royalties due for each copyrighted asset produced.

### CROSS REFERENCE TO RELATED APPLICATIONS

The present application claims priority to and the benefit of U.S. Patent Application No. 60/635,699, filed on Dec. 13, 2004.

### COMPUTER LISTING APPENDIX

This application includes a Computer Listing Appendix on compact disc, hereby incorporated by reference.

### BACKGROUND OF THE INVENTION

1. Technical Field

The present invention relates to method of producing personalized posters, calendars, and the like and more particularly to a method for producing such posters, calendars, and the like which contain copyrighted subject matter and includes a text filter for blocking personalized textual material that may be offensive and optionally includes a royalty-tracking engine for tracking royalties on a per-unit basis of each poster, calendar, and the like (hereinafter “printed product”) that is ordered which incorporates copyrighted subject matter; the system being be web-based or operated from a kiosk.

2. Description of the Prior Art

Various systems are known for producing personalized greeting cards, calendars, and the like. U.S. Pat. Nos. 5,442,567; 5,993,048; 5,717,597; 6,325,503 relate to systems associated with personalized greeting cards. In particular, U.S. Pat. No. 4,948,034 discloses a greeting card which, when opened, functions as a calendar. For example, U.S. Pat. Nos. 5,442,567 and 5,993,048 disclose systems for printing personalized greeting cards. U.S. Pat. No. 5,717,597 discloses a system for printing a postage meter stamp as well as additional indicia on a label or envelope for use with a greeting card. U.S. Pat. No. 6,325,503 discloses a printer for printing two-sided greeting cards.

U.S. Pat. No. 6,536,965 and U.S. Patent Application Publication U.S. 2003/0182210 A1 disclose a system for printing personalized calendars. These calendars include a number of pictures stored in a database, thus allowing the user to select the pictures for the calendars, as well as add any personalized messages. The systems described above, either use “canned” text material or allow the user to create personalized textual material.

The personalized textual material is uncensored by the system and, as such, these systems generally do not legitimately contain copyrighted material as an option for custom calendars and the like. The use of such copyrighted material raises a new issue in that the owners of the copyrighted pictures generally do not allow these pictures to be associated with any offensive material. As such, there is a need to provide a system for generating customized posters, calendars, and the like which allows the use of copyrighted material and, at the same time, filters offensive textual subject matter.

Another problem associated with copyrighted subject matter is royalty tracking. Royalties are normally tracked based on a per-unit basis. Because of the relatively large number of printed products anticipated, royalty tracking can be a very cumbersome task. Thus, there is a need for providing a system which allows printed products to be personalized while preventing offensive material from being used and includes a system for keeping track of royalties for copyrighted material.

### SUMMARY OF THE INVENTION

The present invention relates to a method of producing personalized posters, calendars, and the like (i.e., printed products) which enables users to select from a store of images or other digital assets which may include copyrighted subject matter. The system allows a user to select a stored image for a printed product and incorporate a personalized text message therewith. In order to prevent offensive textual messages, the system includes a text filter for blocking personalized textual material. In an optional embodiment, the system may also include a royalty tracking engine for automatically tracking royalties due for each copyrighted asset produced.

### DESCRIPTION OF THE DRAWINGS

These and other advantages of the present invention will be readily understood with reference to the following drawing and attached specification wherein:

FIG. 1 is a simplified top-level block diagram of the system in accordance with the present invention.

FIG. 2 is a more detailed block diagram of the system illustrated in FIG. 1.

FIG. 3 is a block diagram illustrating an exemplary computer network for the system in accordance with the present invention.

FIG. 4 is an exemplary listing of the content for a data base for use with the present invention.

FIGS. 5-7 are flow diagrams of the system illustrated in FIG. 2.

FIGS. 8-12 are exemplary system flow diagrams for the system in accordance with the present invention.

FIG. 13 is an exemplary report which provides details for two exemplary customer transactions.

FIGS. 14-25 illustrate exemplary graphical user interfaces for use with the present invention.

FIG. 26 is an exemplary flow diagram of a text filter in accordance with the present invention.

FIG. 27 is an exemplary flow diagram of a royalty tracking engine in accordance with the present invention.

FIG. 28 is a chart identifying the picture sizes available based upon the size of the stored image.

FIGS. 29-36 illustrate exemplary database schema for use with the present invention.

### DETAILED DESCRIPTION

The present invention relates to a method of producing personalized posters, calendars and the like (“printed products”) and more particularly to a method of producing printed products which includes a text filter for blocking personalized textual material that may be offensive. The system includes a store of images or other digital assets which may include copyrighted subject matter. Users can select an image for use on a poster, calendar, or the like and incorporate a personal message with it. The images may include copyrighted subject matter, for example, pictures of celebrities. In order to prevent offensive personalized messages from being associated with the images, the system includes a text filter for blocking subject matter which may be offensive. In addition, in an optional embodiment, a royalty tracking engine may be incorporated into the system. The royalty tracking engine is used to track royalties of each copyrighted image or other digital asset that is generated by the system, for example, on a per-unit basis. The system for generating printed products is illustrated in the attached drawing and may be implemented as set forth in the source code attached as an appendix.

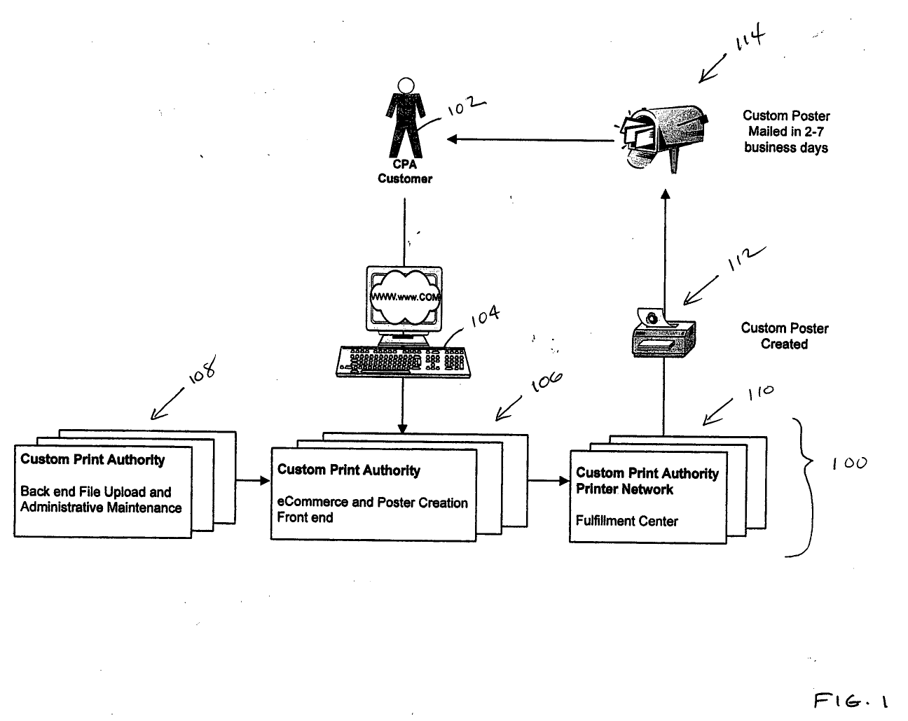

Referring to FIG. 1, a system and method for creating personalized printed products featuring uncopyrighted and copyrighted images including famous sports and entertainment celebrities and events, is illustrated and generally identified with the reference numeral 100. The system 100 may be either web based or kiosk based.

Both web based and kiosk based systems allow consumers to select images from a library of stored images or other digital assets, for example, copyrighted and/or uncopyrighted images and build custom products with images and personalized text, interchanging elements until a unique product is created. In a matter of minutes, using a web browser, for example, a consumer can create a professional looking, one-of-a-kind product. The system 100 is user friendly and includes a graphical user interface (GUI) which obviates the need for programming or graphic arts design skills. Once images have been selected for the printed product, the consumer has an opportunity to personalize the printed product with text. Because of the restrictions imposed by owners of copyrighted materials which prohibit offensive text from being associated with the copyrighted image, the system includes a text filter which prevents offensive language from being printed on the final printed product. Should a consumer enter personalized text which may be considered offensive, the consumer is prompted to select alternative text. Once the product is appropriately personalized, the product is completed and the consumer is prompted to purchase it, for example, via credit card. After credit approval, the digital control file for the customer order is electronically sent to a print partner for immediate printing and fulfillment.

The essential difference between web based and kiosk based systems is the location of the system components. FIG. 1 illustrates a web based system. In a web based system, consumers 102 access the system 100 over the Internet by way of a personal computer (PC) 104 or a personal digital assistant (PDA), not shown. In kiosk based systems, the system 100 can be integrated so that all system components are located at the kiosk, which includes a dedicated workstation for use by a consumer 102 and a high-end printer. As such, in kiosk based applications, consumers 102 instantly receive their customized product. For brevity only web-based applications are discussed hereinafter.

As shown in FIG. 1, the system 100 includes a front-end application 106, a back-end application 108 and a fulfillment center 108. The front-end application 106 is for product creation and is used to serve personalized content to a consumer, selected during a product creation session. The back-end application 108 is used for back-end administrative file uploads and various administrative functions.

The fulfillment center 110 may include one or more high end printers 112 for printing the personalized products. In web-based applications, the fulfillment center 110 is used to print out the final printed product. The fulfillment center 110 is also responsible for mailing the personalized product to the consumer 102 by any one of the various delivery systems, such as the US. Postal Service, or private carriers, generally indicated by the reference numeral 114.

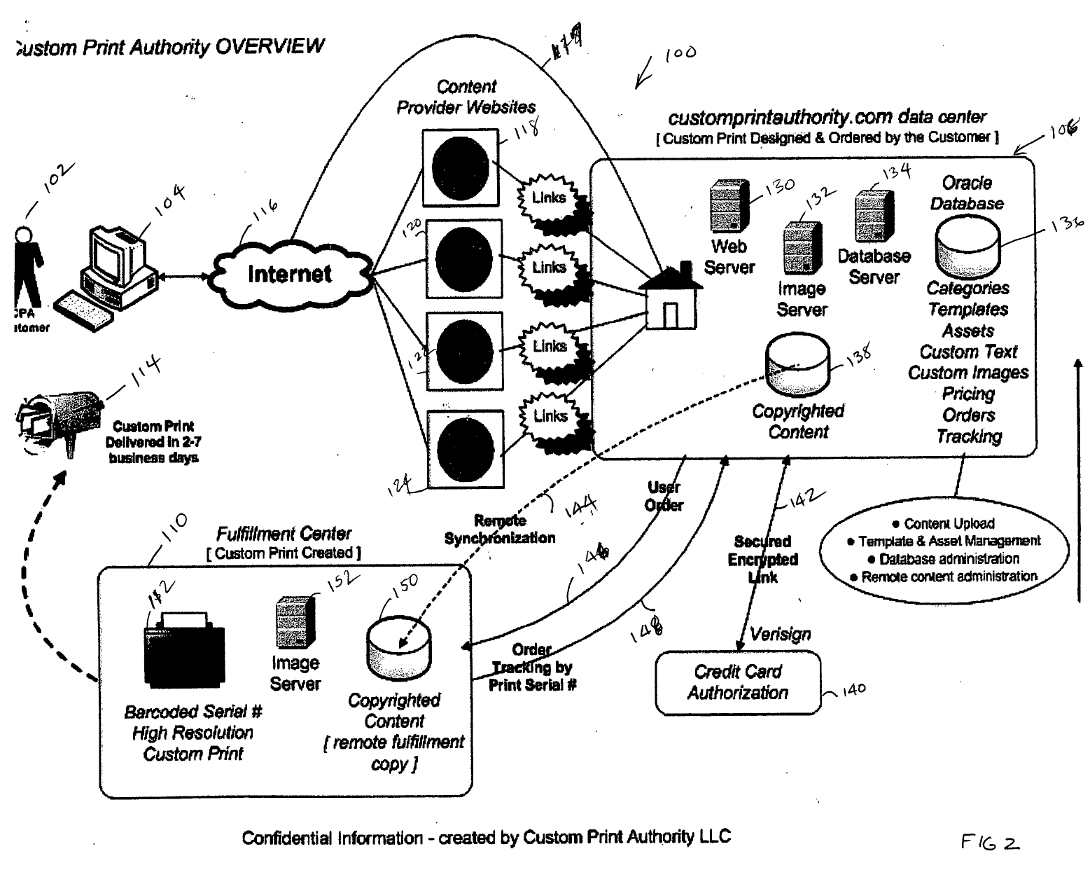

FIG. 2 is a more detailed block diagram of an exemplary web-based application of the system 100 in accordance with the present invention. The web-based application 100 is available over the Internet 116. As shown in the exemplary diagram in FIG. 2, consumers 102 can access the front-end application 106 over a communication link 117. In one embodiment of the invention, the system 100 can be implemented as a tool on one or more third party content web servers 118, 120, 122, or 124, which are linked to the front-end application 106 as discussed above. The front-end application 106 dynamically builds a launch configuration for each entry point into the system 100. Among other things, the front end application 106 may be configured to check the type of browser being used by the consumer 102 and whether the consumer PC 104 is configured for encryption so that a graphical user interface (GUI), discussed below, can be run in a secure mode. If the consumer PC is not configured for encryption, and/or the consumer's web browser is not suitable for the application, a message may be sent to the consumer 102 over the communication link 117. If the consumer's browser is compatible and the consumer's PC 104 is configured for encryption, the front-end application 106 will launch a GUI, which allows the consumer 102 to customize a product. In particular, the GUI is used by the consumer 102 to build a customized product, for example, using Macromedia's Flash 7 software.

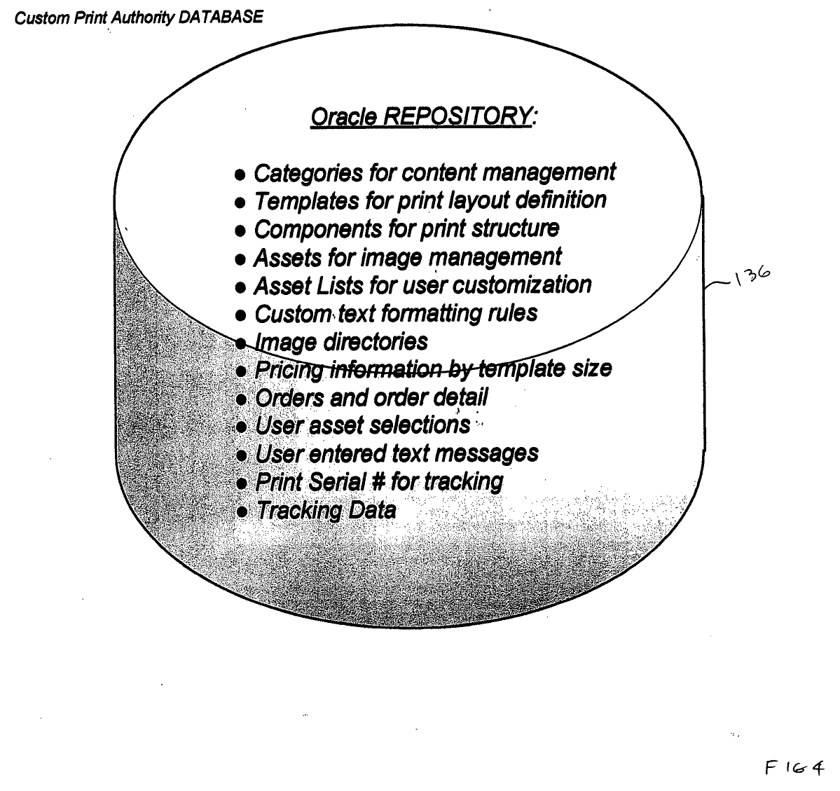

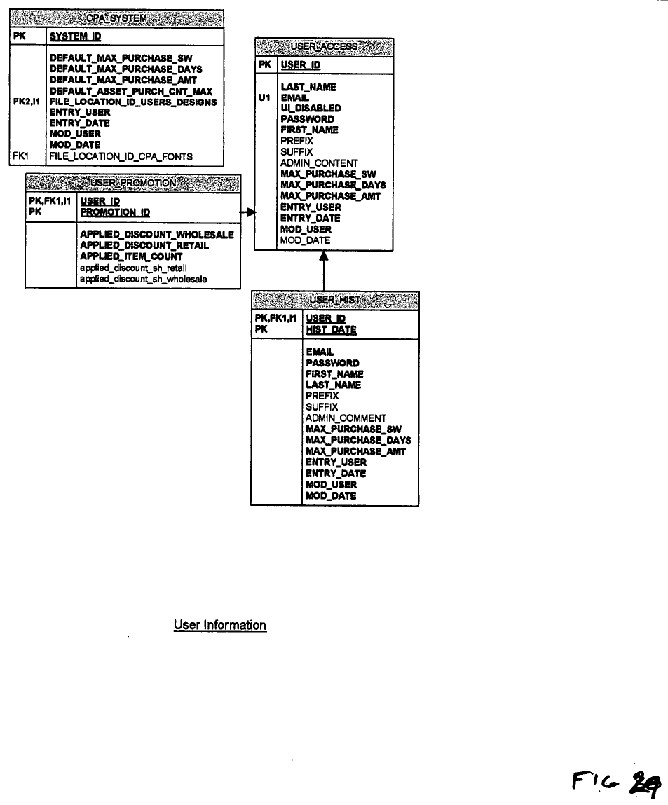

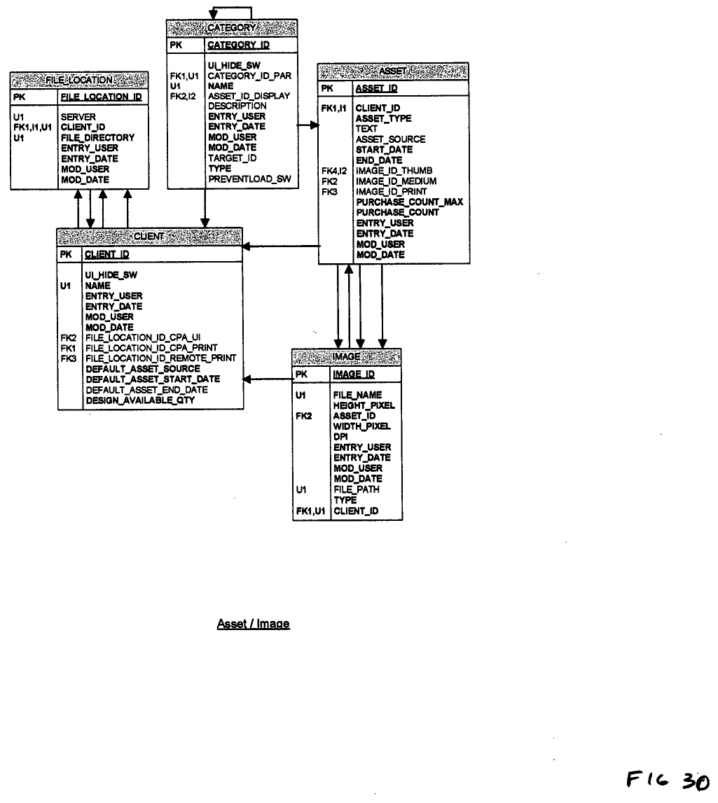

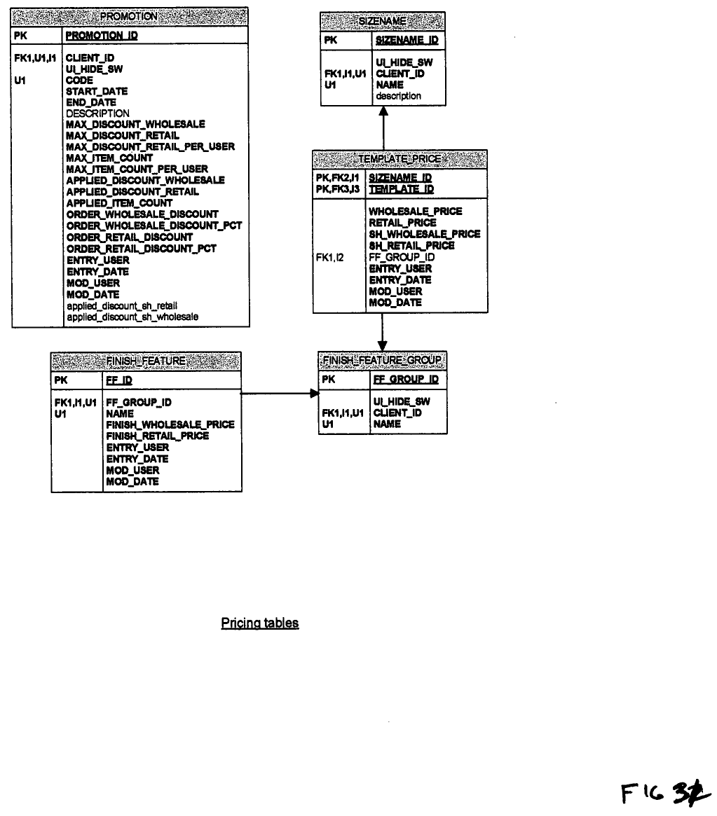

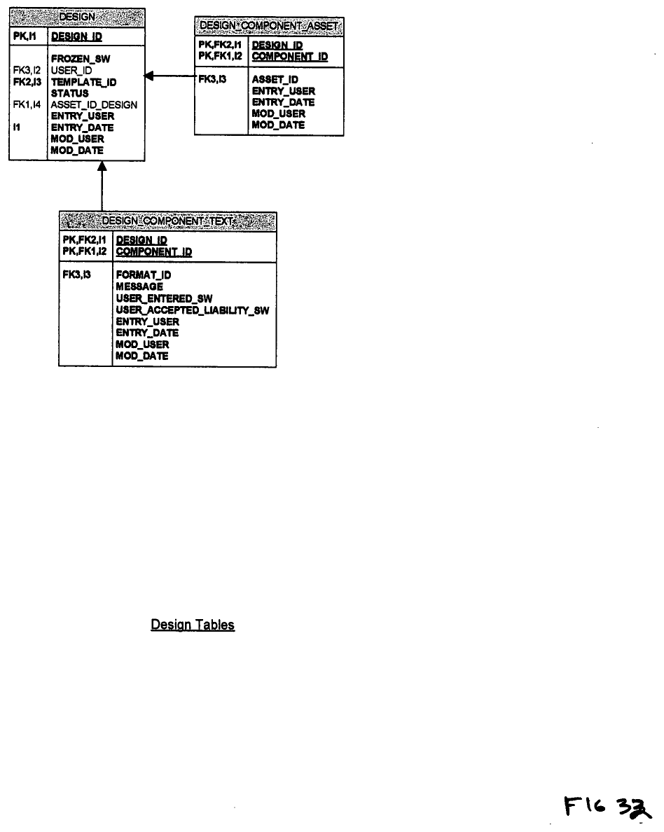

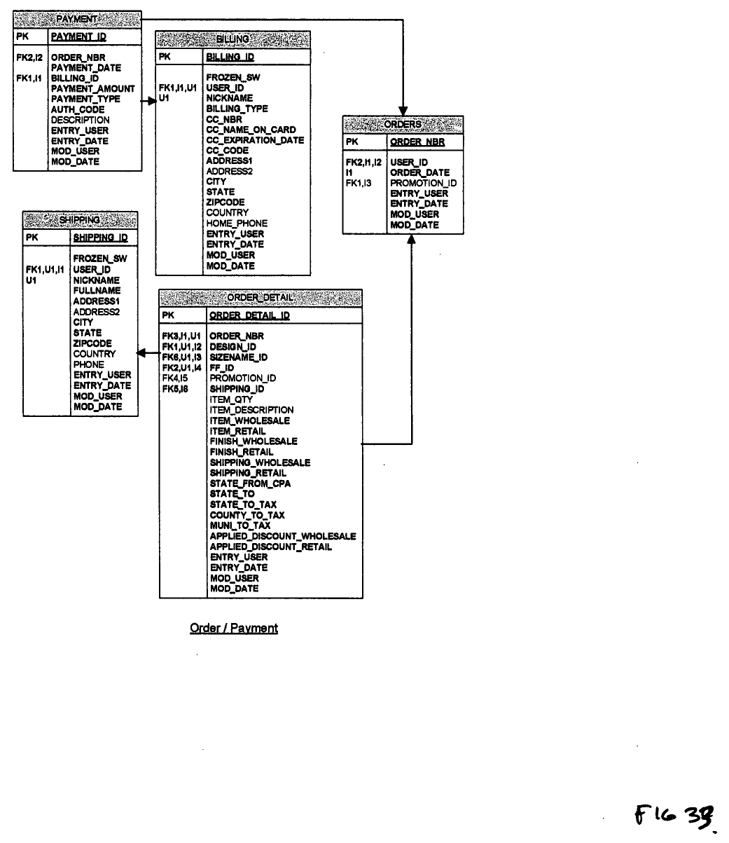

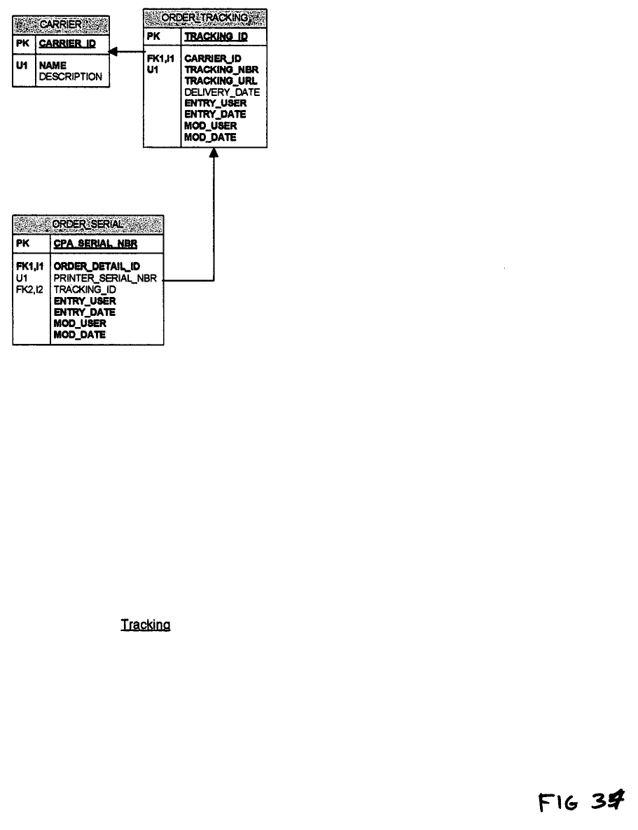

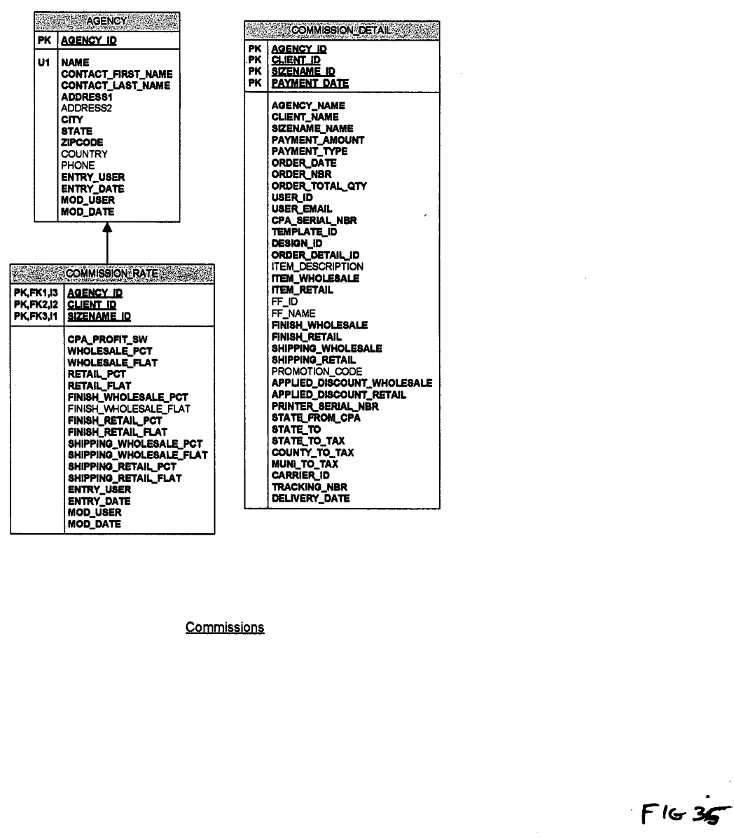

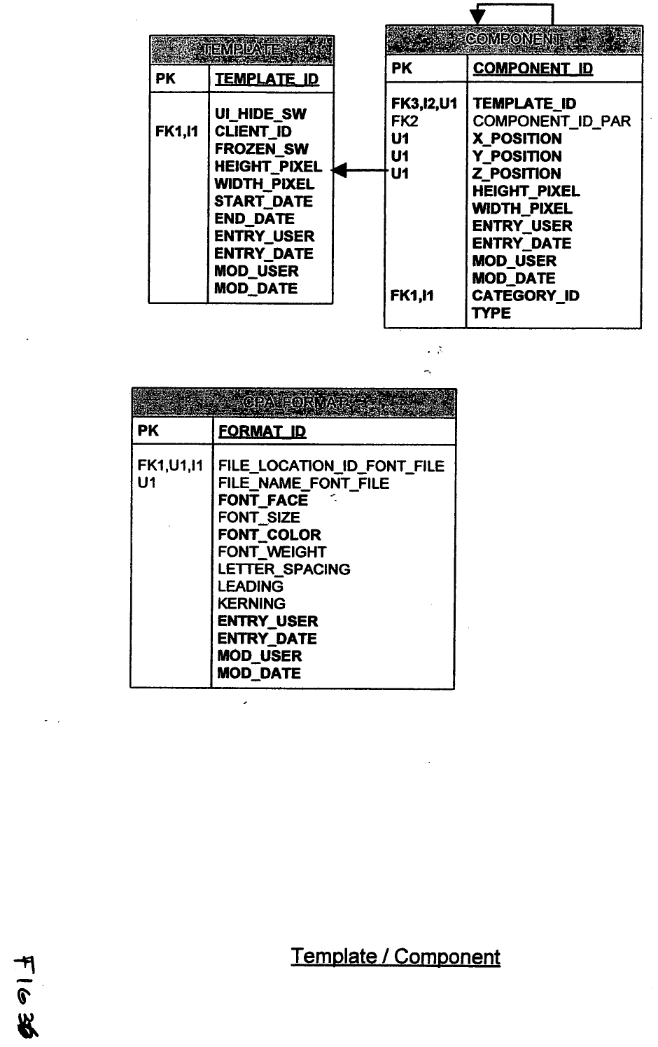

The front-end application 106 may be distributed over a web server 130, an image server 132 and a database server 134. The web server 130 is used to serve static content to the GUI as well as a container for the front-end application 106 used to launch the GUI. The image server 132 is used to process requests for text components and images of the personalized product. The database server 134 provides application logic and database access for various databases used with the system 100. For example, a systems database 136 may be provided. Exemplary content for the system database 136 is illustrated in FIG. 4 and is essentially used for: content uploads; template and asset management; database administration and remote content administration. As shown in FIG. 2, a separate database 138 may be used for copyrighted digital assets (i.e. digital content). FIGS. 29-36 illustrate exemplary schema for the system database 136.

The front-end application 106 may also be used for credit card authorization, generally identified with the reference numeral 140, for example, over a bi-directional secure communication link 142. Additionally, the front-end application 106 may be used to upload an image of the personalized product to the fulfillment center 110 by way of a communication link 144 and user order information over a communication link 146. The fulfillment center 110 returns order tracking information, such as a print serial number, to the front end application 106 byway of a communication link 148.

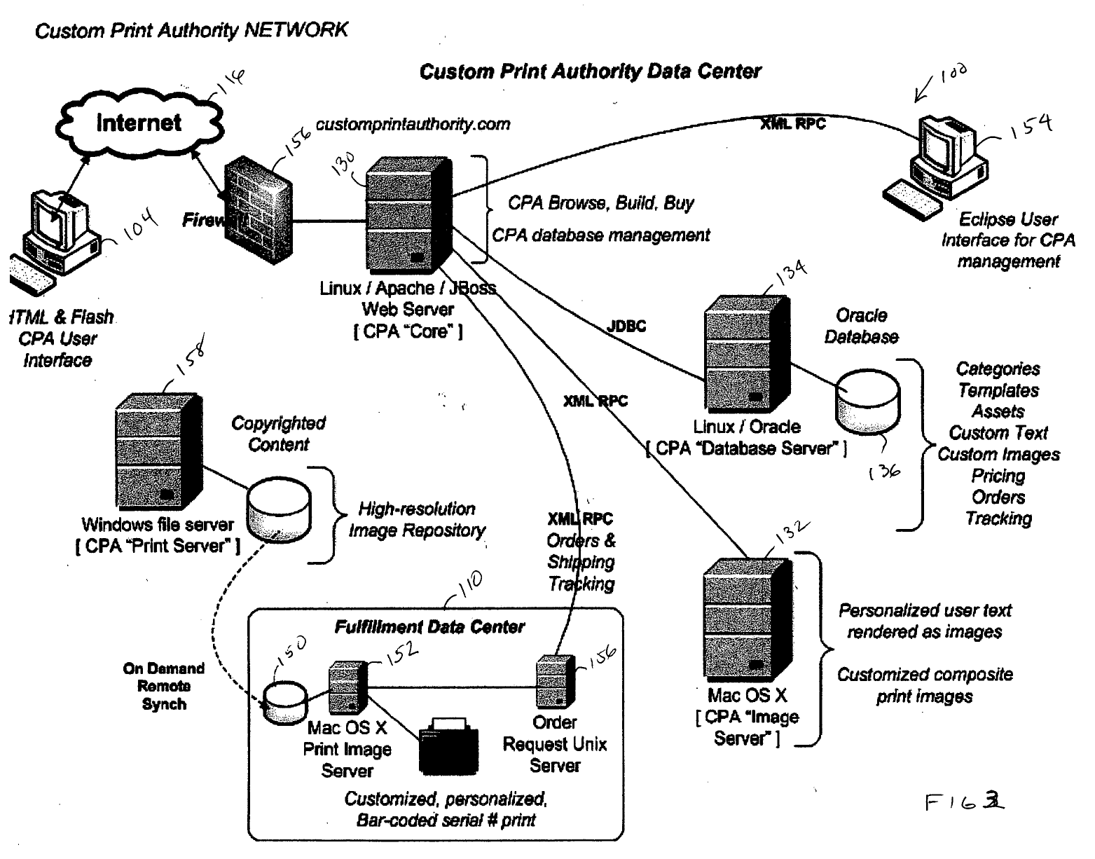

The back-end application 108 may be configured so that it is not accessible by any consumers 102. The back-end application 108 is only accessible by administrative personnel, for example, by way of a management interface by way of a remote PC or work station 154 (FIG. 3).

The fulfillment center 110 may include a database 150 for receiving an image of the customized product. The image of the customized product is served to a printer 112 by an image server 152. The image server 152 may also assign a unique bar coded serial number to each customized product to be associated with the customized product and return a serial number to the back-end application 108 by way of the communication link 148 for storage in the system database 136. In web-based applications, the fulfillment center 110 is also responsible for mailing the customized product to the consumer 102.

FIG. 3 illustrates an exemplary network diagram for the system 100. As shown, consumer 102 access to the front end application 106 system 100 is by way of a PC 104 over the Internet 116. For protection, the system may be protected by a firewall 156. As mentioned above, the front-end application 106 may be distributed over three or more servers, for example, a web server 130, a database server 134 and an image server 132. The web server 130 may be connected to the image server 132 and the database server 134 as well as the management interface PC 104 and the fulfillment station 110.

The web server 130 may be an Apache server running on either a Linux or Win32 operating system. The image server 132 may be Mac web server running an OS X operating system while the database server 134 may be a JBoss Java application server running on a Linux operating system and including a database application, such as Oracle. The management interface PC 154 is a standard PC with a back-end interface application, such as Eclipse.

The fulfillment center 110 may include an order server 156, for example a Unix server and a print image server, for example, a Mac server running on the OS X operating system. The order request server 156 is coupled to the web server 130 as well as the image server 152. The print image server is coupled to a print server 156, for example, a Windows file server, which, in turn is coupled to high resolution printers 112 (FIG. 1).

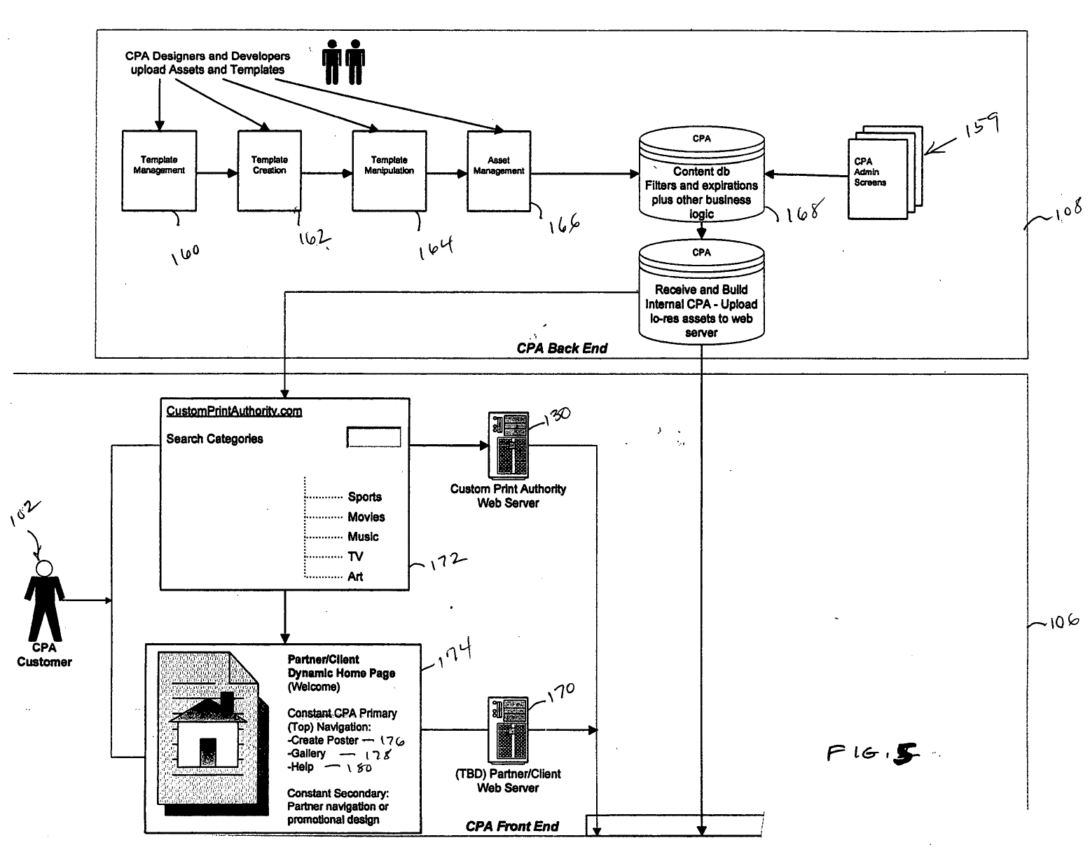

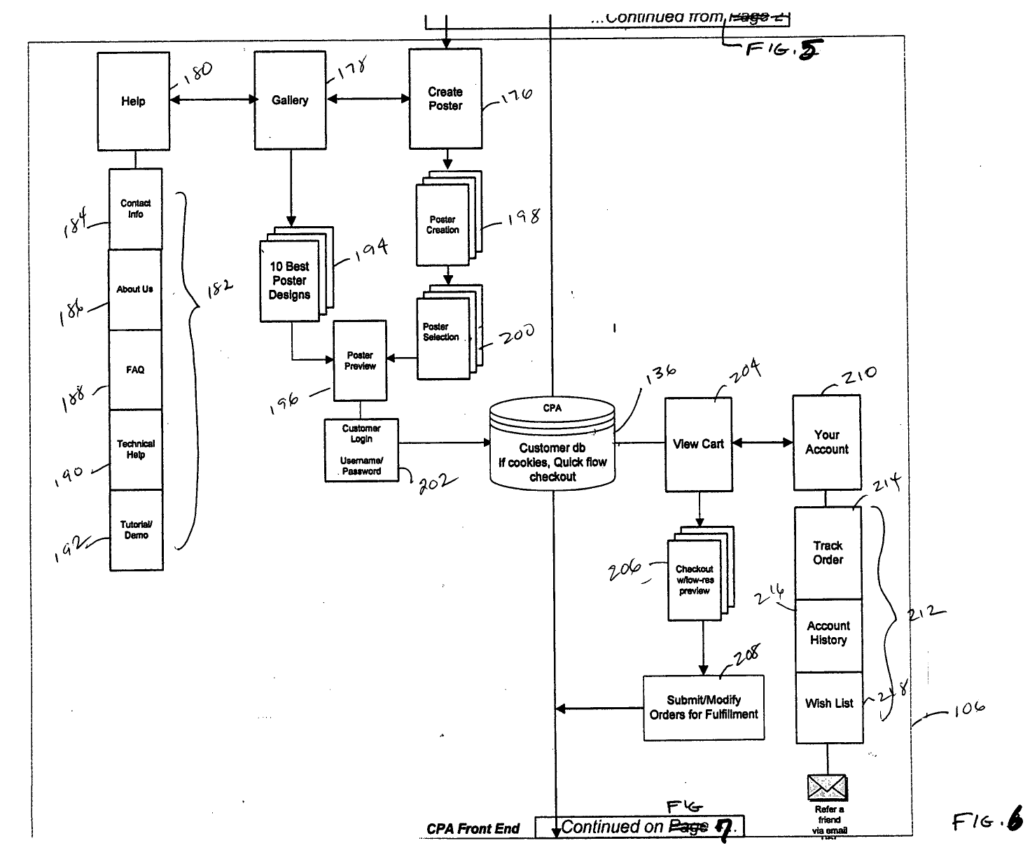

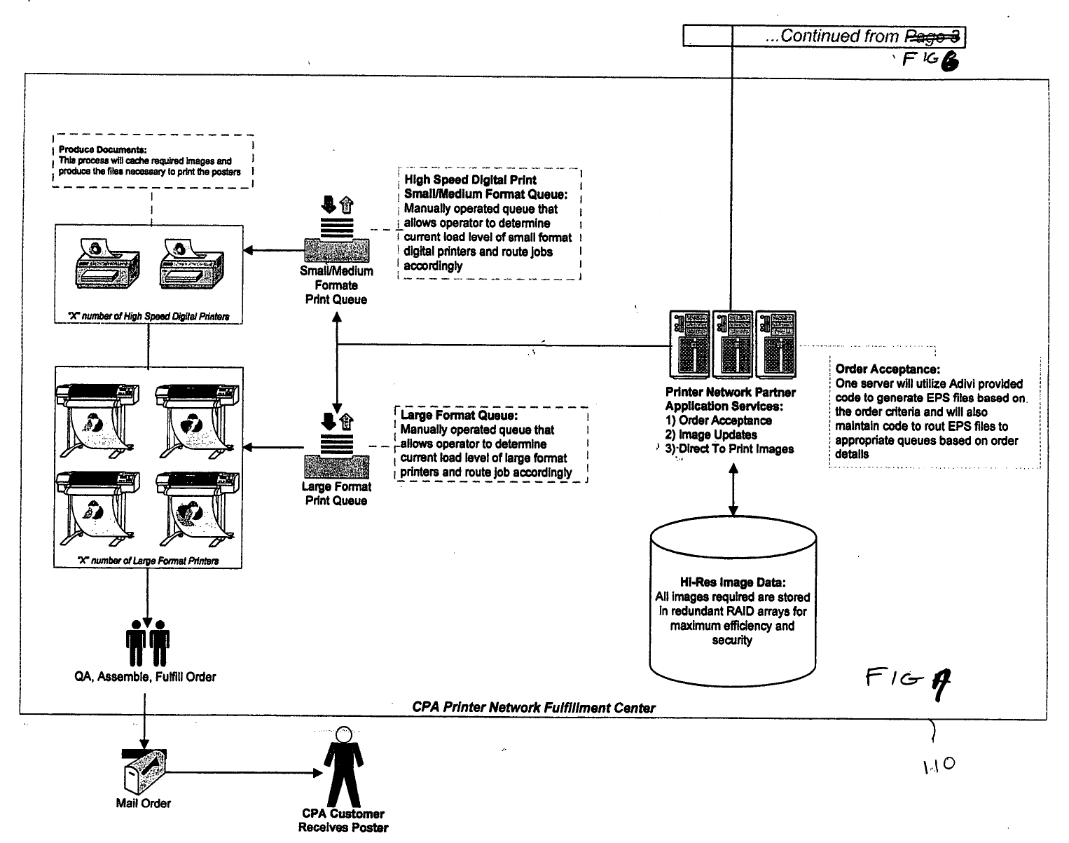

FIGS. 5-7 are flow diagrams of the system 100. FIGS. FIG. 5 illustrates a flow diagram of the back-end application 108. FIG. 5 also illustrates a flow diagram for an embodiment of the front-end application 106 which includes an optional third party web server 170 used to launch the application in accordance with the present invention. FIG. 6 is a flow diagram of the balance of the front-end application 106. FIG. 7 is flow diagram of the fulfillment station 110.

Referring first to FIG. 5, the back-end application 108, resident on the management interface PC 154 (FIG. 3) is used, for example, by administrative personnel, such as designers and developers, by way of an administrative interface 159 for various functions, such as, template management 160, template creation 162, template manipulation 166 and asset management 166 (i.e. uploading digital assets or content). The templates and content are stored on a database 168 and uploaded to the web server 130.

As mentioned above, a consumer 102 can access the system 100 at different entry points. For example, access to the system may be provided by a home web page 172, hosted by the web server 130. Access to the system can optionally be provided by way of a partner or third party server 170 by way of a web page 174. As shown, the web page 172 may be configured to enable a consumer 102 to select from various content categories, such as sports, movies, music, TV and art. The format of the web page 174 may include various navigation buttons, such as: create poster 176; gallery 178 and help 180.

Turning to FIG. 6, selecting the help button 180 causes a tool bar 182 to be displayed. The tool bar 182 may include various exemplary navigation buttons, such as: “contact info” 184; “about us” 186; “faq” 188; “technical help” 190 and “tutorial/demo” 192.

The “gallery” navigation button 178 on the web page 174 is used to enable the consumer 102 to browse the various digital assets available on the system 100. In particular, once the consumer 102 selects the “gallery” navigation button 178, various canned products are displayed in step 194 and individually previewed in step 196.

The “create poster” navigation button 176 is used to customize a product, such as a poster. After the “create poster” navigation button is selected, the consumer proceeds to select a template and digital content for the custom product as well as adds personalized text, as indicated in step 200.

After the consumer 102 creates a personalized product, the consumer 102 can purchase the product by logging into the system, as indicated in step 202. The consumer information, as well as an image file of the personalized product, are stored in the system database 136. If the consumer has previously ordered, as indicated by the cookies or other files stored on the database 136, indicating that the client account information is already on file, the system 100 proceeds directly to check out Otherwise, the consumer 102 must select a “view cart” navigation button 204 before checking out in step 206 with a low resolution preview by selecting a check-out button. After, the consumer 102 checks out, the order is submitted for fulfillment in step 208. Consumers 102 may alternatively modify previously entered orders in their cart in step 208 before checkout.

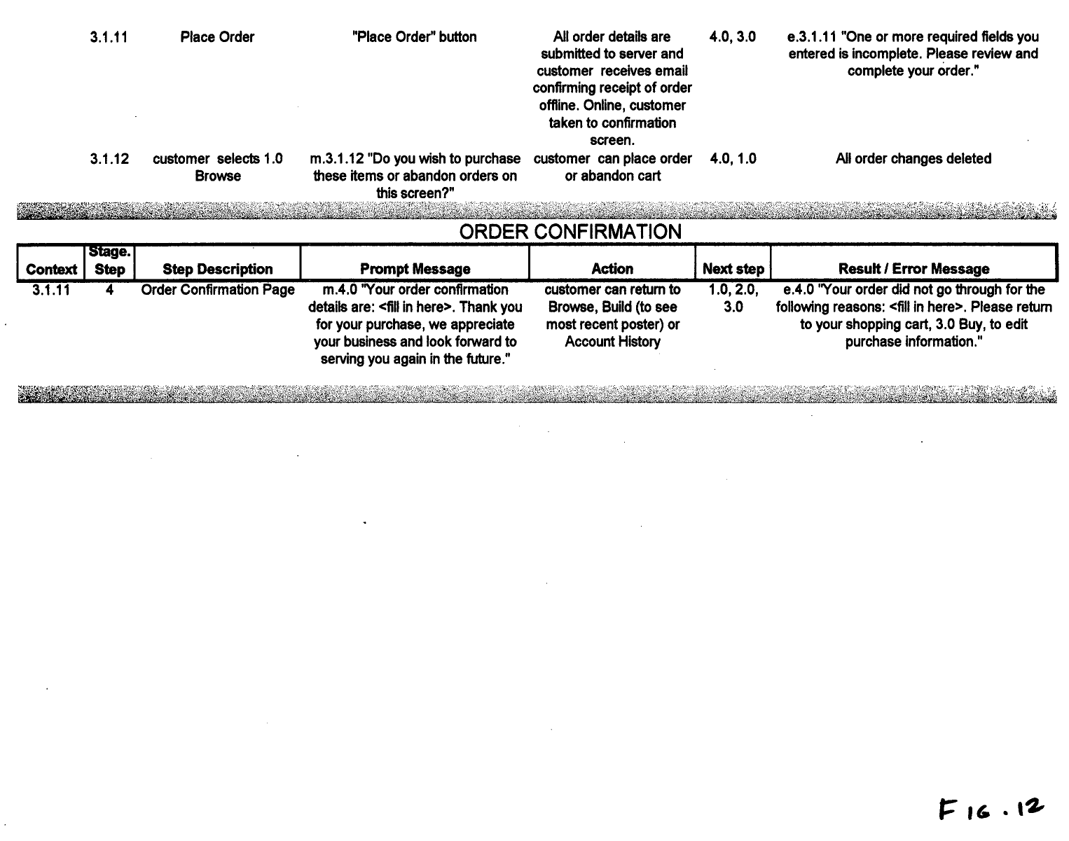

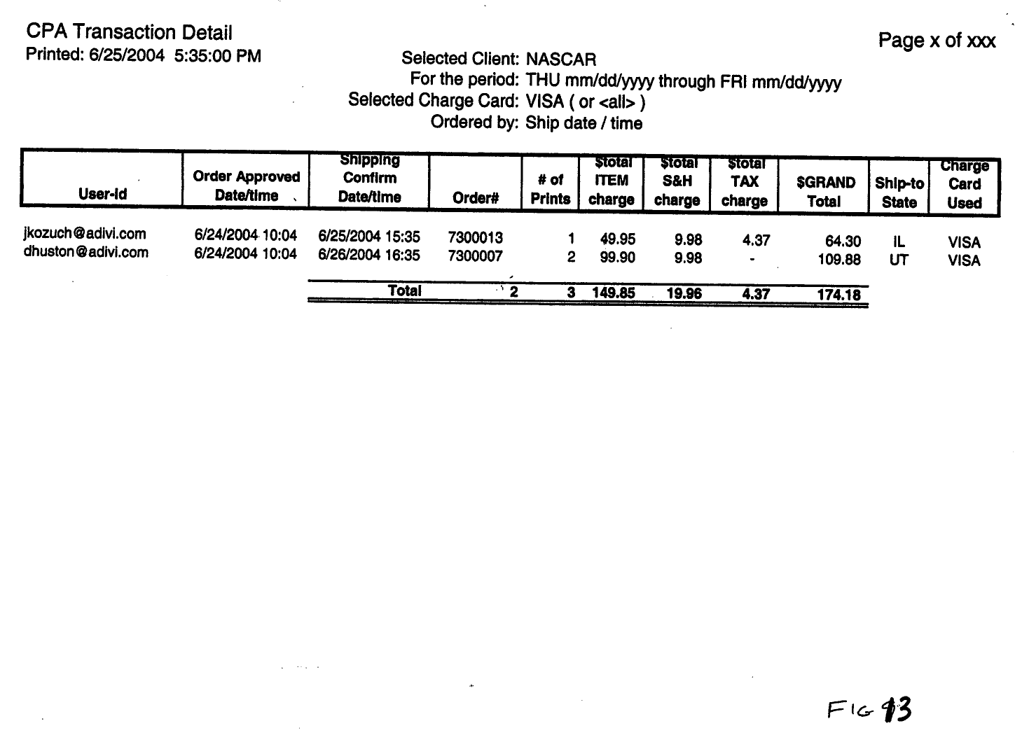

The system 100 may also provide consumers an opportunity to view their account by selecting a “your account” navigation button 210. When the “your account” navigation button 210 is selected, a tool bar 212 is displayed. The tool bar 212 may include three exemplary navigation buttons: “track order” 214, “account history” 216 and “wish list” 218. When the consumer selects the track order navigation button, an order confirmation report is returned, similar to the order confirmation report illustrated in FIG. 12. When the “account history” navigation button 216 is selected an account history report is returned, similar to the report illustrated in FIG. 13. The wish list navigation button 218 allows a personalized product to be created with a request for payment by a third party.

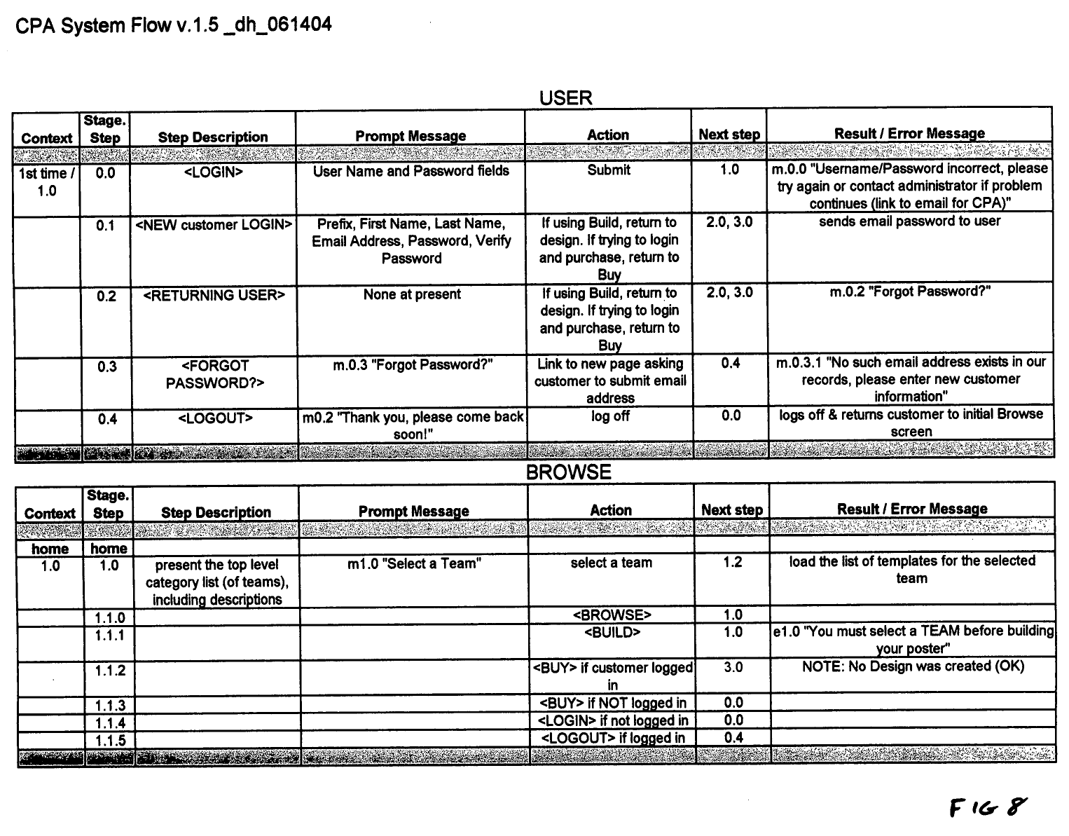

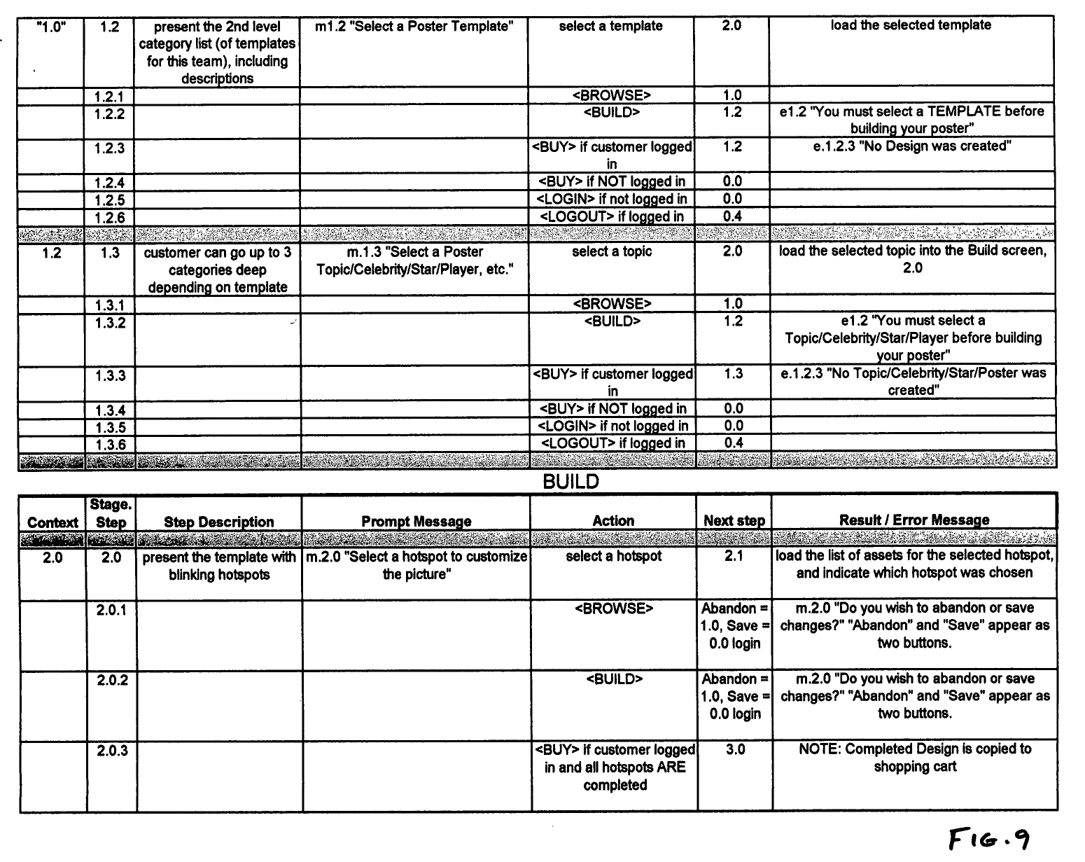

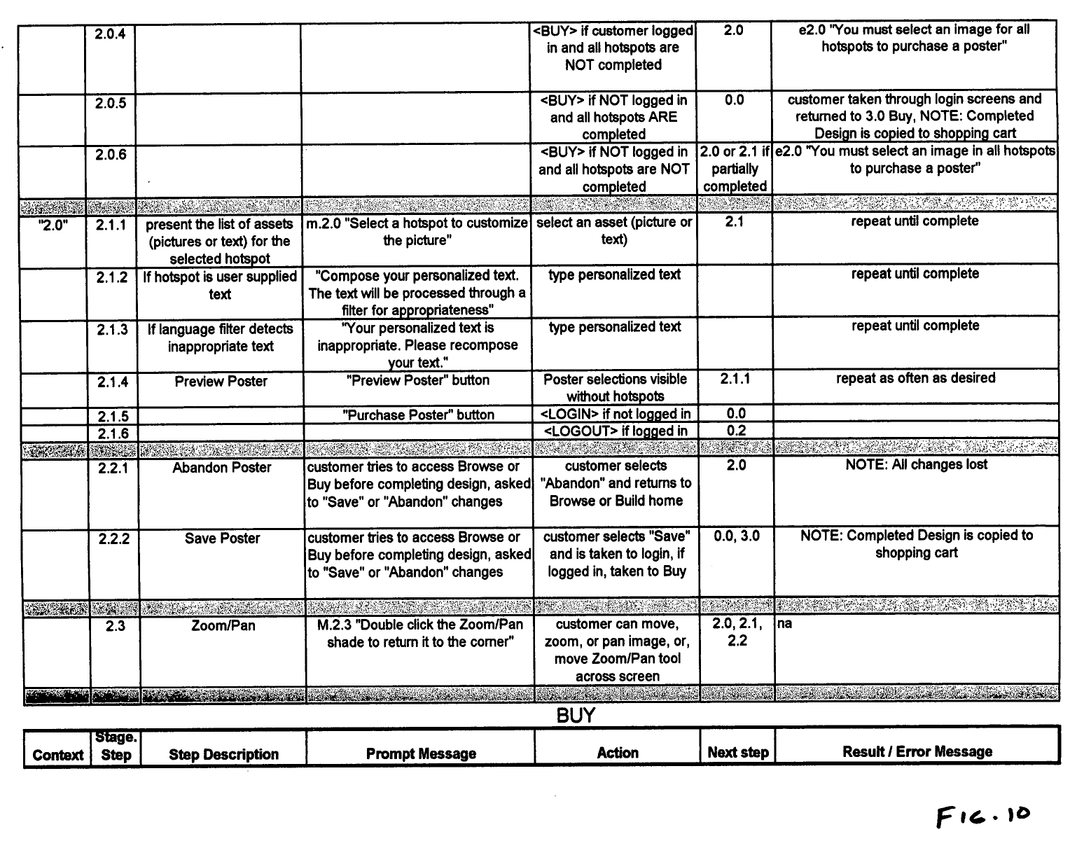

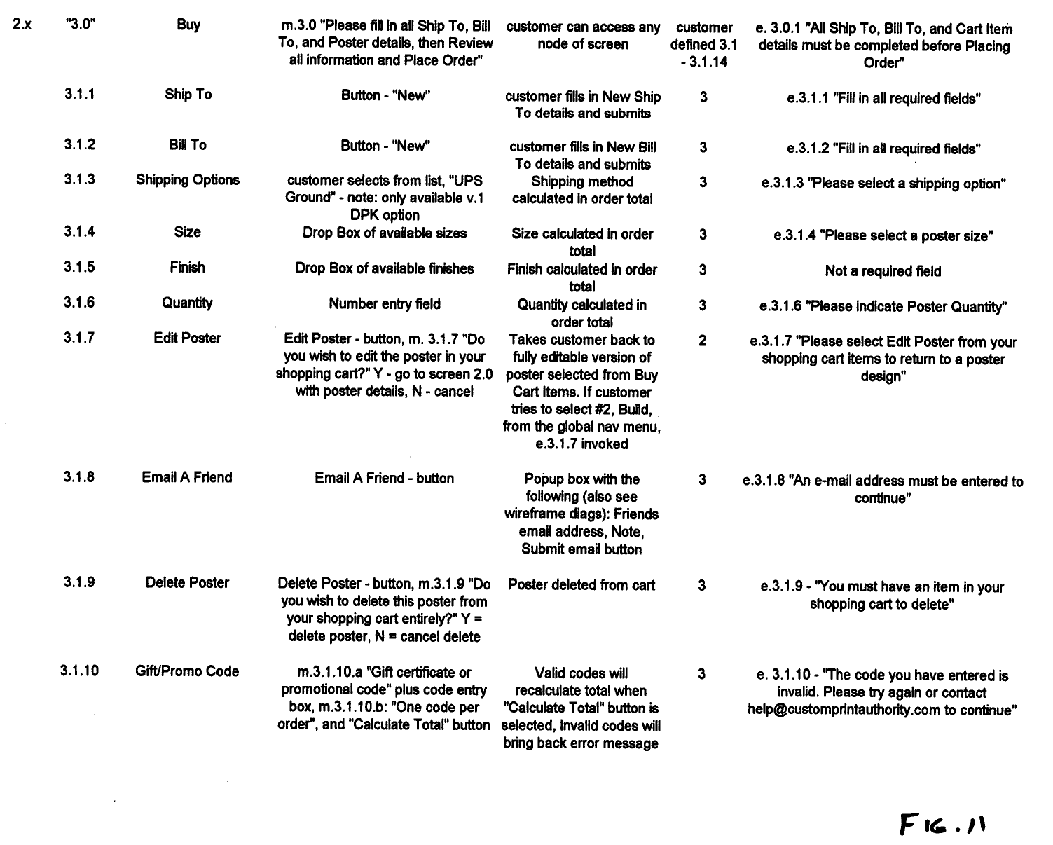

FIGS. 8-12 illustrate more detailed exemplary flow diagrams of the system 100 in tabular form. As shown, steps 0.0 to 0.4 relate to consumer log-in to the system. Steps 1.0-1.3.6 represent the flow during browsing of the digital assets by the consumer 102. Steps 2.0-2.3 illustrate the steps taken when a consumer customizes a product. Steps 3.0-3.12 illustrate the steps associated with purchasing a custom product. Step 3.1.11, illustrated in FIG. 12, illustrates an exemplary order confirmation report. FIG. 13 illustrates an exemplary account history report.

### Graphical User Interface

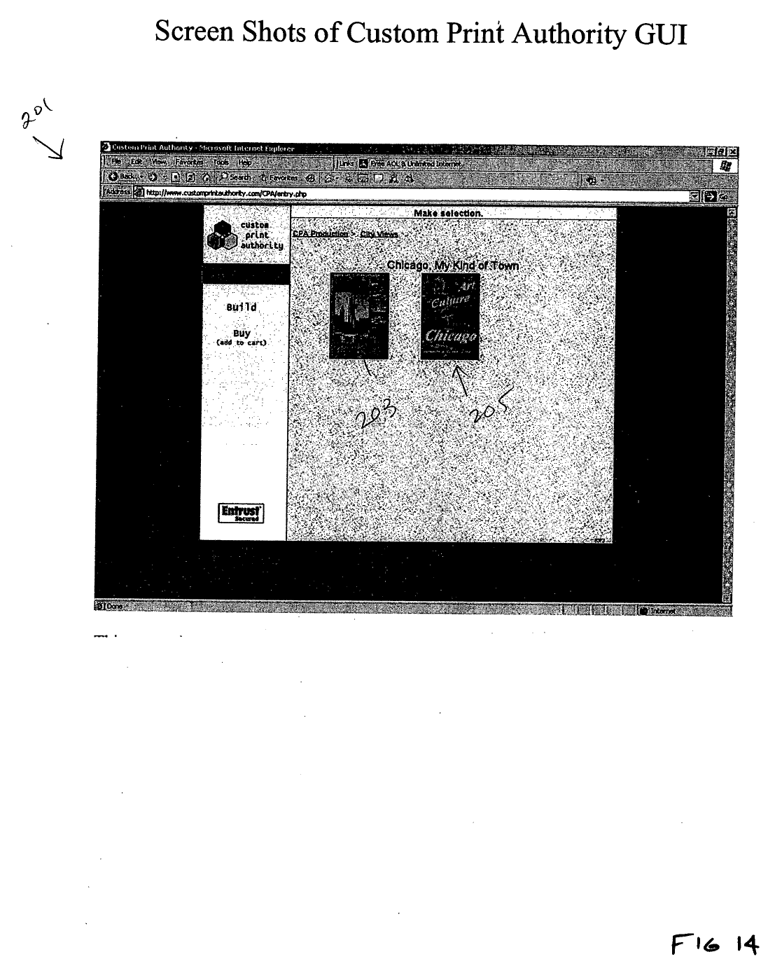

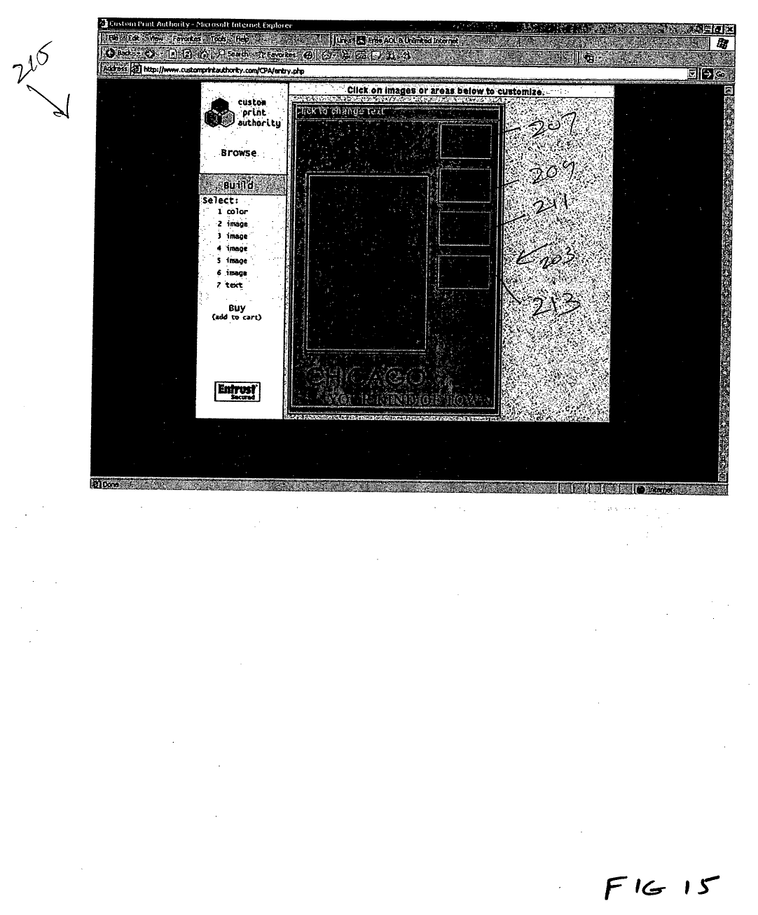

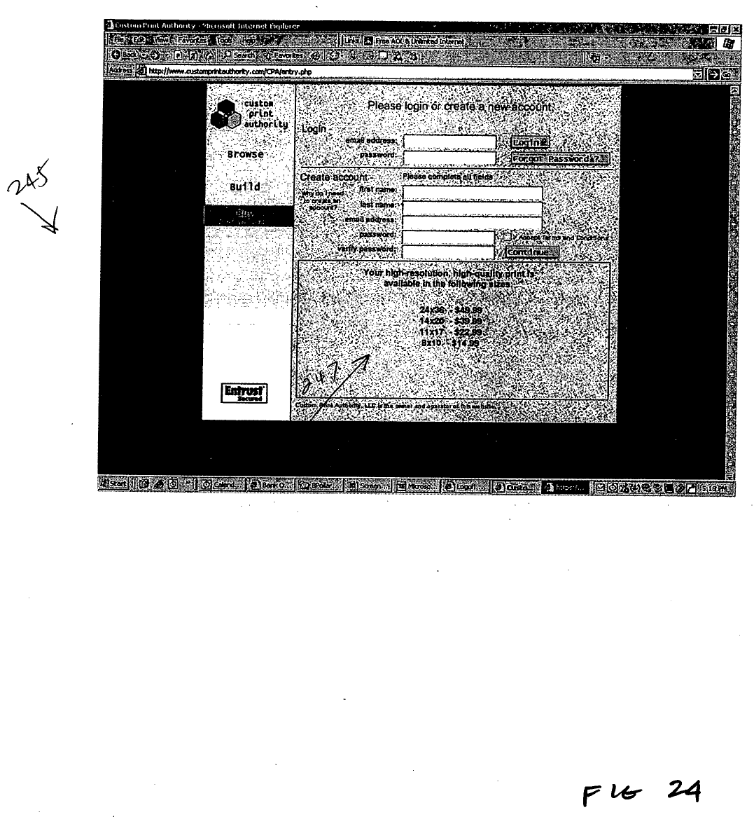

An exemplary graphical user interface (GUI) is illustrated in FIGS. 14-25. FIG. 14 illustrates a “browse” web page 201 for selecting a template for a personalized product. As shown in FIG. 14, the web page 201 illustrates two exemplary templates 203 and 205. The template 203 is shown better in FIG. 15. As shown, the template 203 illustrates an exemplary format for a personalized product which includes a primary image box 205 and one or more secondary image boxes 207, 209, 211 and 213. Returning back to FIG. 14, once the consumer selects a template for a personalized product, a build web page 215 is launched. An exemplary build web page 215 is illustrated in FIG. 15. The build web page 215 allows a consumer 102 to select images for the image boxes 206-213, as well as colors, text calendars and the like. In the exemplary web page browse web page 215, illustrated in FIG. 15, various hot spots are created. As the consumer moves the cursor over the hot spot, various choices are presented.

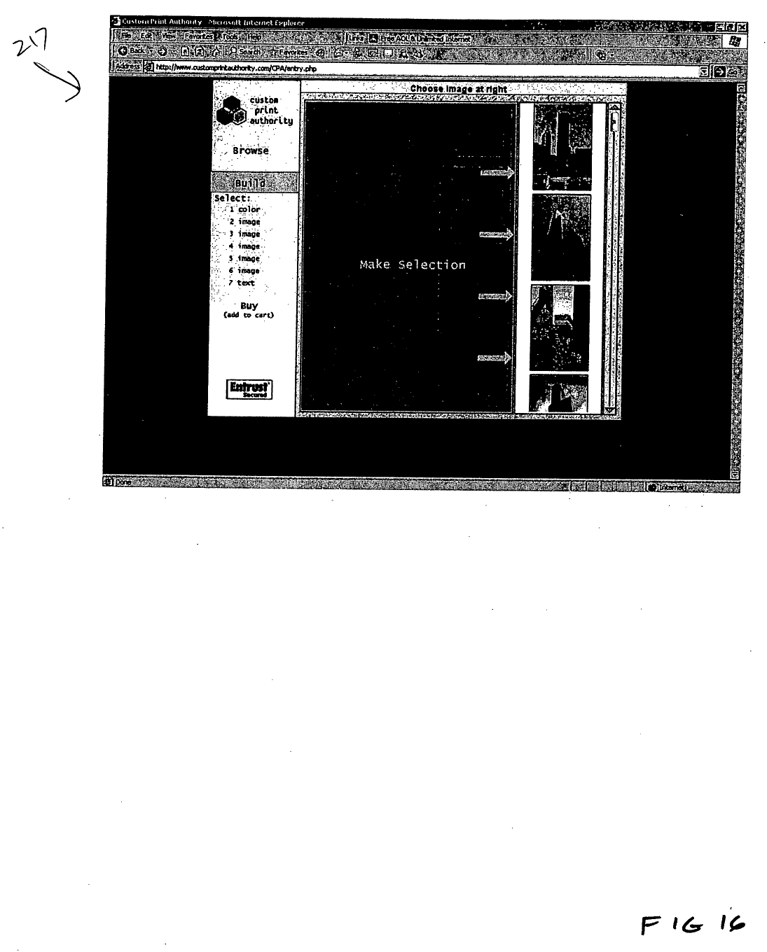

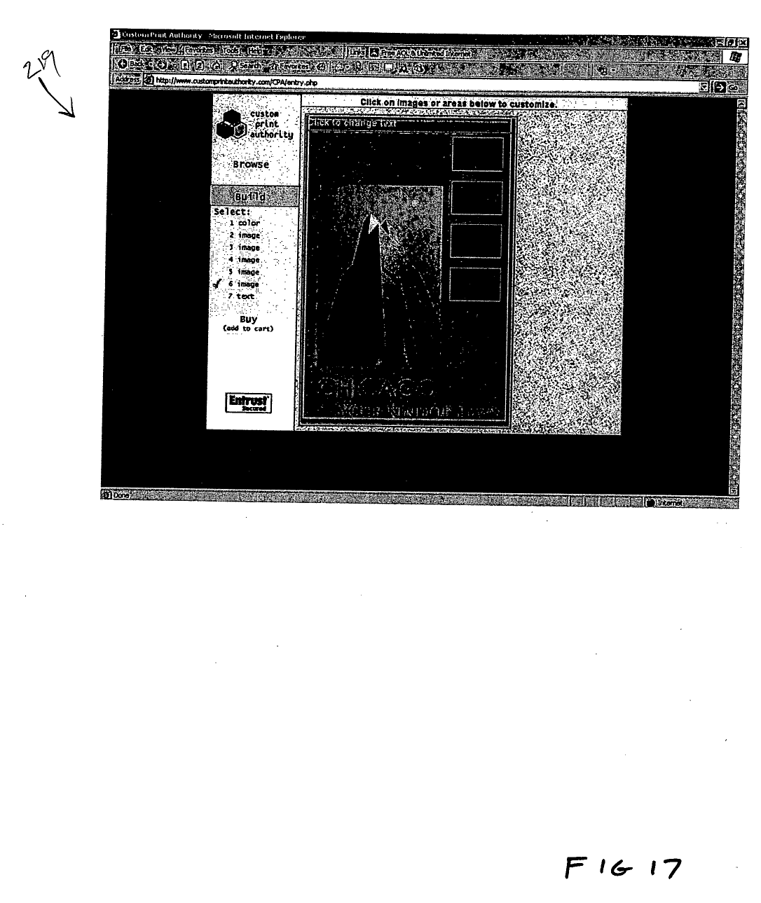

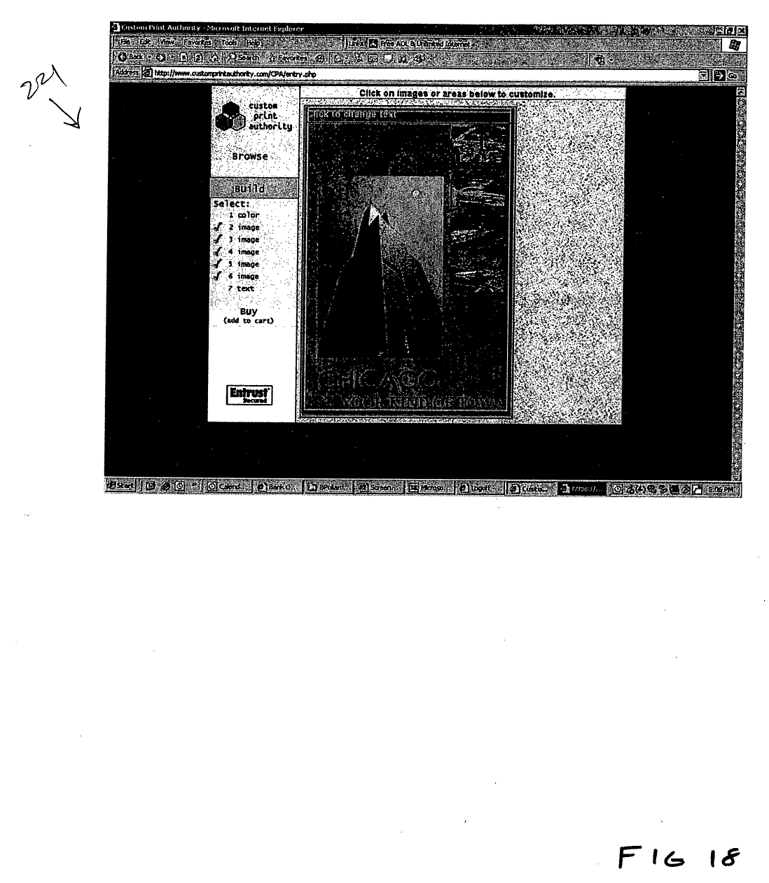

FIG. 16 is an example of a personalized product illustrated on a exemplary web page 217. As shown in FIG. 16, as the consumer selects images for the various image boxes 207-213, the selections are shown as indicated. FIG. 16 illustrates a condition when the consumer has made selections for the secondary image boxes 207-213. FIG. 17 illustrates a web page 219 which illustrates a condition when the selection has been made by the consumer for the primary image box 206. As shown in FIG. 17, a check mark is added to the left of the selection under the “select” heading. The check mark indicates that a consumer has made a selection for the particular hotspot. The consumer can then continue to fill in the product with other selections. FIG. 18 illustrates a condition 221 when all of the image boxes 206-213 have been selected by the consumer. Check marks are indicated under the select box for all of the images.

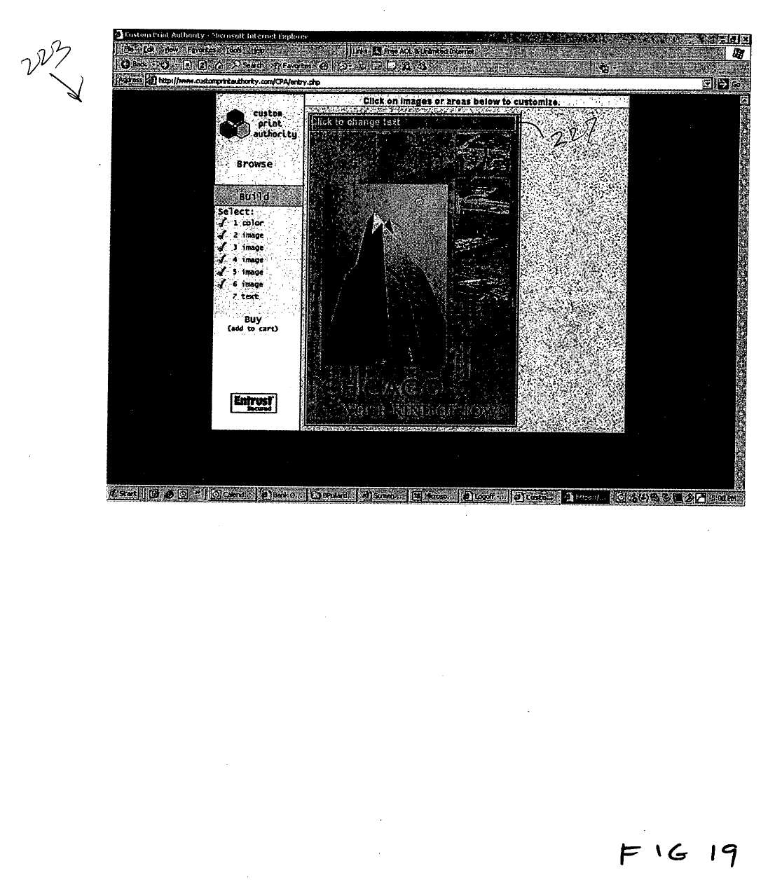

FIG. 19 illustrates an exemplary web page 223 in which another exemplary characteristic for the personalized product is selected. In this particular case, the characteristic is, for example, color. The color can be selected from a wide variety of colors which are automatically presented to the consumer when the cursor is over portions of the customized product other than the personalized boxes 206-213. As shown, a check mark is located under the select box next to color.

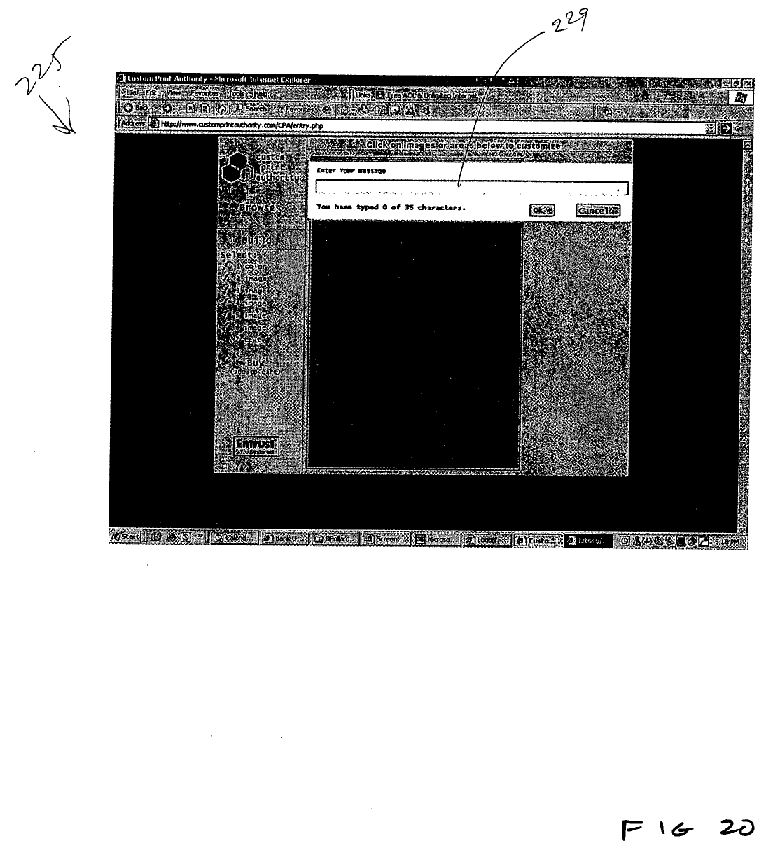

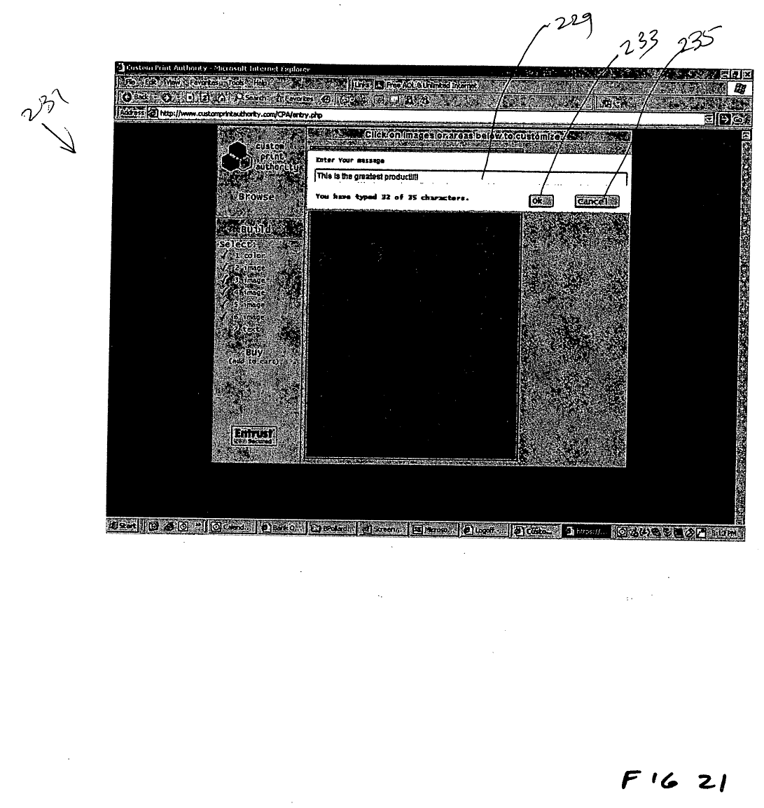

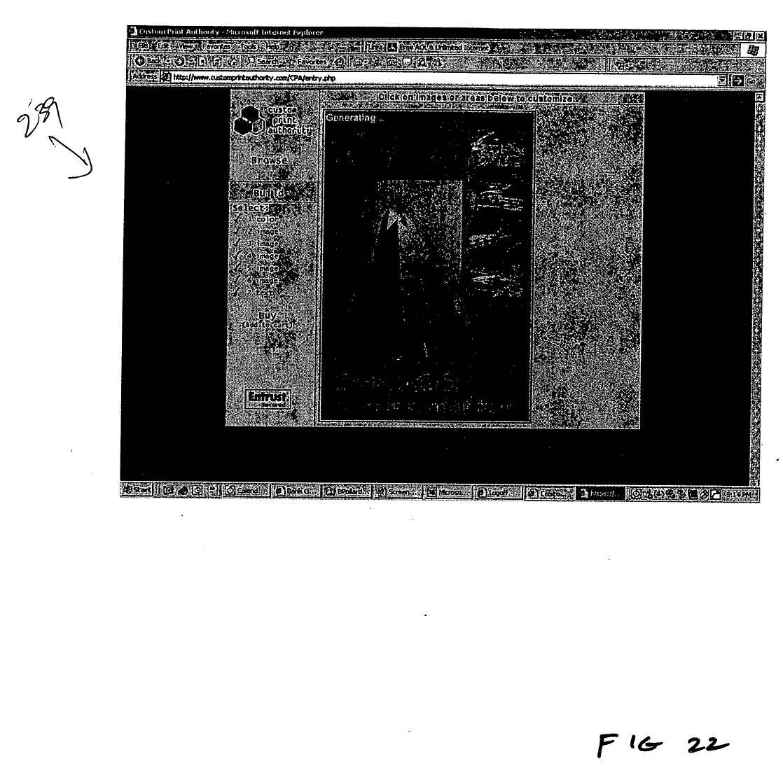

FIG. 20 illustrates a web page 225 which enables personalized text to be added to a personalized product. Returning first to FIG. 19, a text selection box 227 is provided at the top of the template. The text selection box 227 allows a consumer 102 to add personalized text to the personalized product. In order for the consumer to add personalized text, the personalized text button 227 is selected After the personalized text button 227 is selected, a dialog box 229 is provided. The personalized text is entered into the dialog box 229. As will be discussed in detail below, before the personalized text is actually added to the custom product, the personalized text is directed to a text filter to filter out any offensive material from the final printed product. FIG. 21 illustrates a web page 231 which illustrates that personalized text has been added to the dialog box 229. Two buttons are provided; an “ok” button 233 and a “cancel” button 235. If the consumer does not desire any changes to the personalized text added to the dialog box 229, the “ok” button can be selected to add the text to the product, as shown on the web page 239 (FIG. 22). As will be discussed in more detail below, the text is filtered, by way of a text filter, to prevent offensive material from being added to the final printed product. If the consumer wishes to make a revision to the personalized text added to the dialog box 229, the cancel button 235 is selected. Selection of the cancel button clears the dialog box 229 and allows the consumer to re-enter personalized text.

FIG. 22 illustrates an intermediate web page 29 which illustrates that the text has been selected by way of the check mark next to the word text. FIG. 22 also indicates the status of the personalized product. In the example illustrated in FIG. 22, the status is indicated as “generating.”

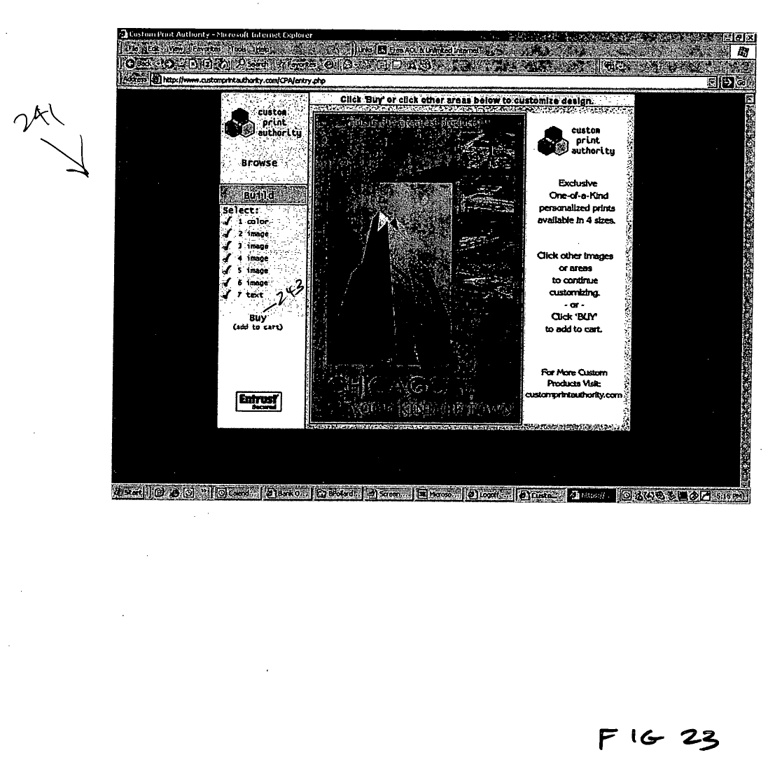

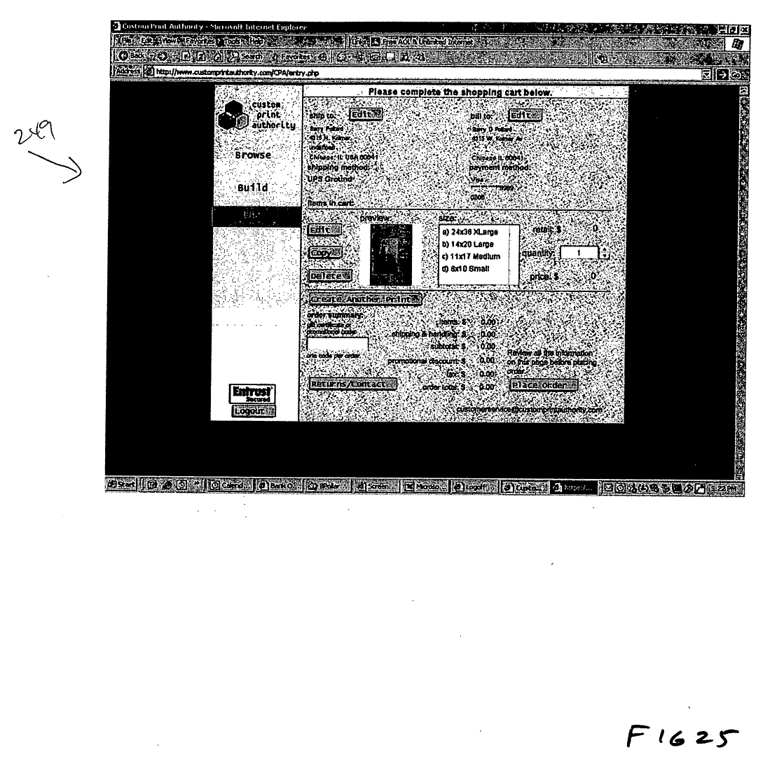

FIG. 23 illustrates a completely personalized poster that is ready to be purchased. In order to purchase the poster, the consumer simply clicks on the “buy” button 243. After the consumer clicks on the “buy” button, a web page 245 is presented with an account dialog box 247. The account dialog box 247 allows the consumer 102 to create a user name and password the first time that the shopping cart section is entered, so the product can be tracked. After the log-in is created, the account dialog box can be used to create an account to purchase the product. FIG. 25 illustrates an exemplary order confirmation screen after a valid log in. As noted, the order confirmation screen 249 may include shipping data, size selection, preview of the poster and a place order button. Once all the information is entered by the consumer a personalized product is sent to the consumer.

### Text Filter

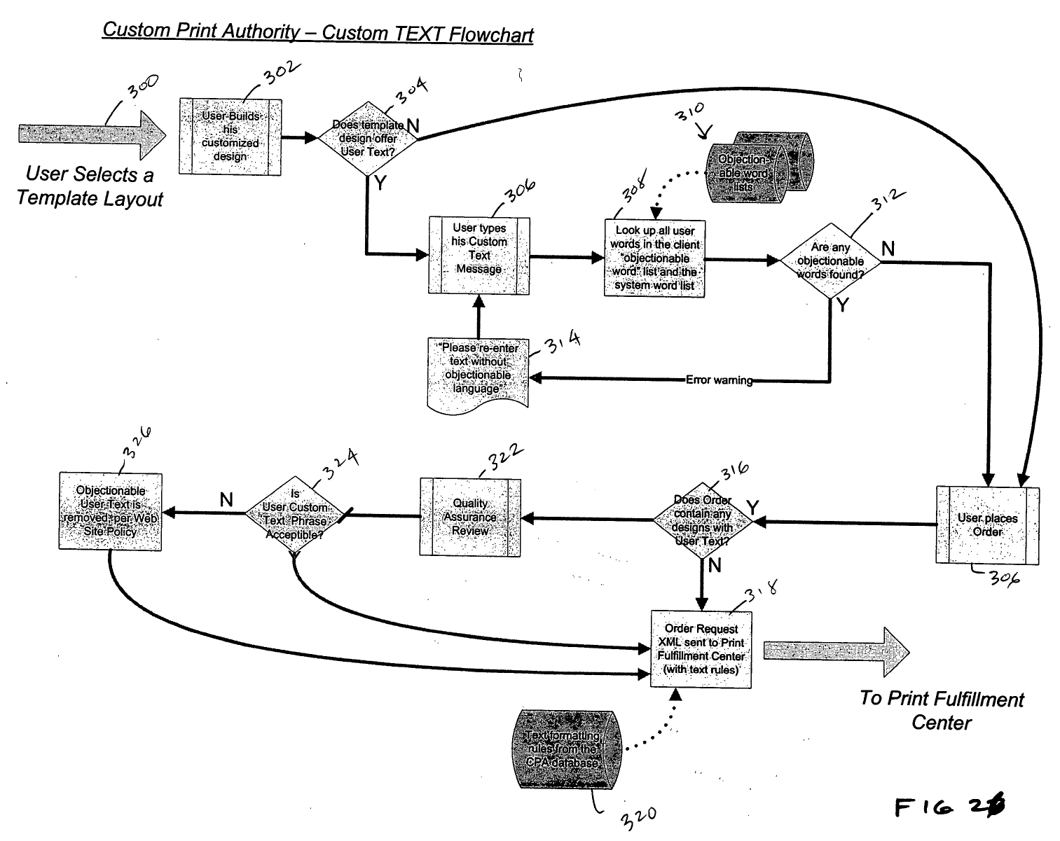

An important aspect of the invention relates to a text filter, as illustrated in FIG. 26. As mentioned above, the system in accordance with the present invention allows a consumer 102 to add personalized text to create a personalized product. In order to prevent offensive material from being added to a custom product, a text filter is provided. Referring to FIG. 26, a flow chart for the text filter is provided. Initially, as discussed in connection with the GUI, a consumer 102 selects a template design and customizes the template as discussed above and indicated by the arrow 300. The system first checks in step 304 if the template offers personalized text. If not, the system returns to step 306 to allow the user to place an order. If the selected template does offer the ability to personalize text, the system 100 allows the user to type in a text message in box 306, as illustrated by the web page 231 (FIG. 21). After the consumer 102 types in the personalized text message, the text filter looks up all of the words in the message to determine if there are any objectionable words in the personalized text in step 308. The text filter may include, for example, a system objectionable word list as well as an additional client objectionable word list stored in files or databases, generally identified with the referenced numeral 310. After all of the words in the text personalized text are looked up and compared with the objectionable work lists, the system 100 ascertains in step 312 whether any of the selected words are objectionable words. If not, the system returns to step 306 to allow the user to place the order. If the personalized text message does contain objectionable words, the system returns an error message in step 314 requesting the user to re-enter the personalized text without the objectionable language. The system then repeats steps 306 and 308 and 312.

Once the order is placed, the system checks in step 316 whether the selected personalized product contains user text. If not, the system sends the order to the print fulfillment center in step 318. Prior to the order being sent to the print fulfillment center, the customized text may be formatted by way of text formatting rules from an external database 320.

Assuming the personalized product does include custom text, an optional second level quality assurance review may be performed in step 322. The quality assurance review may be conducted by a human operator which checks the personalized product to make sure that the final product does not include an objectionable message formed entirely from non-objectionable words. After the quality assurance review is performed, the system next checks in step 324, whether the text phrase is acceptable. The system then checks in step 326 to make sure that all objectionable text has been removed, and, if so, returns to step 318 to send the order to the print fulfillment center. If not, the final product is sent to the fulfillment center without text.

### Royalty Tracking Engine

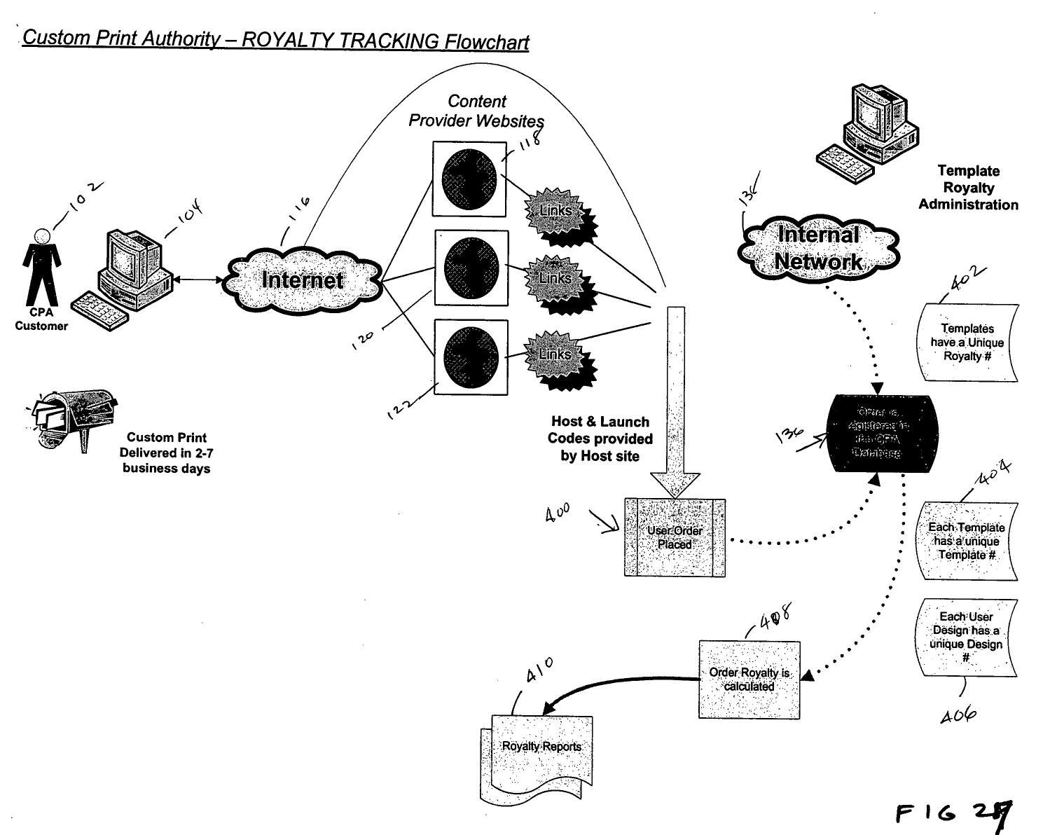

A royalty tracking engine is illustrated in FIG. 27. As mentioned above, the system 100 in accordance with the present invention allows customized products which include copyrighted images. In order to avoid copyright infringement violations, the system is provided with a royalty tracking engine, as illustrated in FIG. 27. FIG. 27 illustrates a simplified flow chart for a royalty tracking engine. As mentioned above, as illustrated in connection with FIG. 2, the system 100 may also be launched from various third party content provider web sites, illustrated with the reference numerals 118, 120 and 122.

Initially, a consumer 102 places an order by way of a PC 104 over the Internet 116. The order is placed, as generally indicated by the box 400, and as discussed above. Should the consumer 102 select copyrighted images for use in a personalized product, the image is linked to the system 100. As discussed above, all copyrighted images may be stored on a database 138 (FIG. 2). Once a consumer 102 selects copyrighted subject matter, the order is registered in a database 136 (FIG. 2). Each copyrighted image is assigned a unique royalty number, as indicated by the boxes 402 and 404. In addition, each personalized product is assigned a unique design number, as indicated by box 406. Thus, any time a personalized product is ordered by a consumer 102, which utilizes copyrighted images, a royalty is automatically calculated, as indicated by the box 408 which may be used to optionally generate a royalty report, as indicated by the box 410.

### Asset Standards

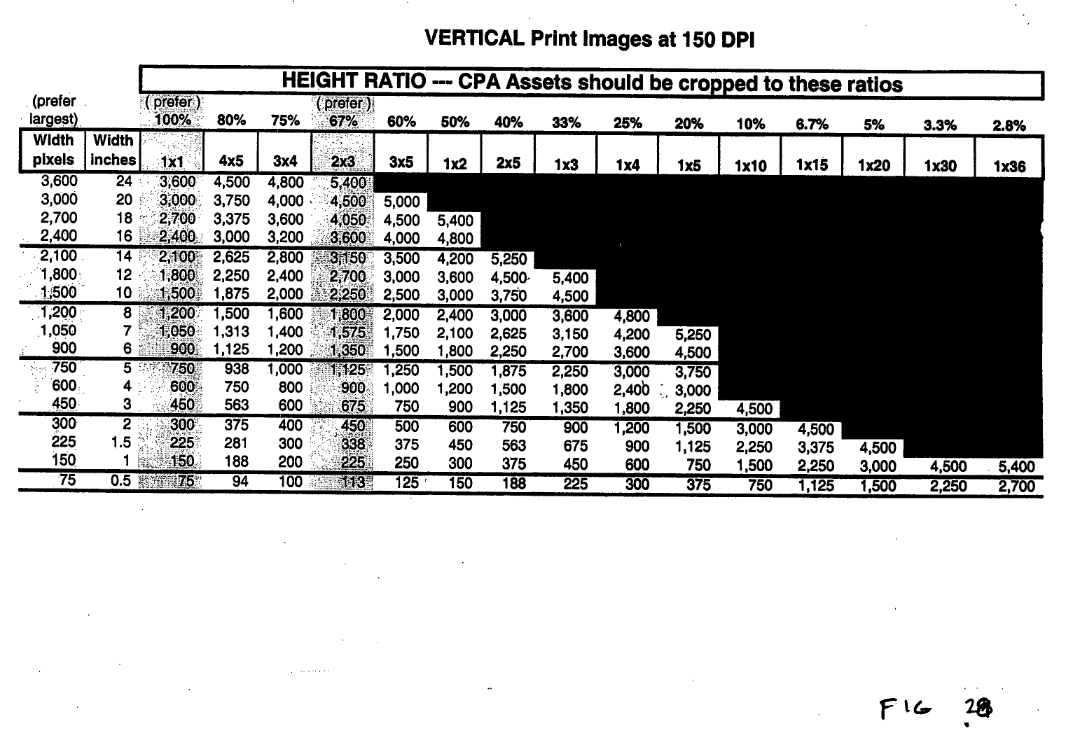

In order to enable maximum image re-usability in multiple poster templates, each image or “asset is preferably prepared to the exemplary standard as follows:
For images with no transparency, JPG files are required.
For images with transparency, PNG files are required.
For cropped images, see FIG. 28. Assets must be cropped and saved at 150 DPI (dots per inch). Images should never be scaled down to prevent loss of quality. If the source image is less than 150 DPI, then the prepared image will need to be smaller in order to preserve the saved image quality at 150 DPI. In other words, quality is more important than size. Any 150 DPI asset that is smaller than 900×900 pixels (6″×6″) is too small and should not be used.
Cropping should be done at high resolution, prior to scaling-down an image.
JPG or PNG quality attribute must not be changed (retain its current setting) prior to saving the image.
Assets must be “full print size”: 5400×3600 pixels (3x2 ratio—36″×24″ horizontal), 3600×5400 pixels (2x3 ratio—24″×36″ vertical), or 3600×3600 pixels (1x1 ratio—24″×″ squares and circles). This is done so that we may re-use the images in multiple templates.

### Exceptions

Exception 1: Smaller assets are permitted only when the source material is not high enough quality to maintain 150 DPI at the “full print size”. Such images must be saved at 150 DPI, and cropped to multiples of 150 pixels_(1″) in the preferred ratios 3x2, 2x3, or 1x1 at the largest size possible that will continue to maintain 100% quality. For example, an image saved at 3600×2400 is preferred over one that is 1800×1200 so long as the 150 DPI and quality are the same.
Exception 2: Some template designs may required assets at other ratios such as 1x2, 2x1, 4x5, 3x5, etc. These special case asset sizes are less likely to be re-useable in other templates. For this reason, examples of such templates must be discussed with CPA prior to creation of the templates and assets.
Exception 3: Brand and Team logo sizes are generally able to be resized to fit within the CPA preferred 1x1, 3x2, or 2x3 ratios, with transparency, at 150 DPI. Logos of different size must be cropped to 1″ multiples at the largest size possible that will continue to maintain 100% quality.

### Text Pull-Down Choices

Text pull-down choices may be re-used in several templates. The designer must create 7 to 9 different text phrase choices per text pull-down. Text assets are preferably created as static graphics by the designer.
Each text phrase is saved as a separate file (each text phrase is a separate asset).
Text files should be 150 DPI, with transparency (PNG).
Text files should be 5400×900 pixels (6x1 ratio—36″×6″ horizontal), or 900×5400 pixels (1x6 ratio—6″×36″ vertical).
Text assets should “fill-out” the 1x6 or 6x1 canvas area (they should be maximized to fill-out to the left and right edges of the canvas area). Note, this means that the letters in long phrases with many words may appear to be smaller in size than in brief phrases.
   Formatting (color, font, shading, etc.) should be the same for all text pull-down choices.

### Banners and Names

Must be 150 DPI, with transparency (PNG).
Each banner or name is saved as a separate file (each is a separate asset), in addition to its being defined in a template.
Horizontal banners and names are sized as 5400 (36″) x multiples of 150 pixels (1″). For example: 5400×600, 5400×750, 5400×900 etc.
Vertical banners and names are sized as multiples of 150 pixels (1″)×5400 (36″). For example: 600×5400, 750×5400, 900×5400, etc.

Obviously many modifications and variations of the present invention are possible in light of the above teachings. Thus, it is to be understood that, within the scope of the appended claims, the invention may be practiced otherwise than is specifically described above.

What is claimed and desired to be secured by a Letters Patent of the United States is:

We claim:

1. A method for enabling a consumer to create a personalized printed product, comprising the steps of:
a. providing a template for a printed product which includes at least one image box which can be personalized by a consumer from a selection of at least two images;
b. providing at least one dialog box on said template which enables a consumer to provide personalized text on said printed product;
c. automatically filtering said personalized text to prevent unpermitted personalized text to be printed on said product; and
d. incorporating the selected image and personalized text into the template.

2. The method as recited in claim 1, wherein step (a) comprises
a. providing a template for the printed product which includes at least one image box which can be personalized by a consumer from a selection of uncopyrighted images.

3. The method as recited in claim 1, wherein step (a) comprises
a. providing a template for the printed product which includes at least one image box which can be personalized by a consumer from a selection of copyrighted images.

4. The method as recited in claim 3, further including the step of e) tracking the use of copyrighted images.

5. The method as recited in claim 4, further including the step of:
(f) calculating royalties for the use of said copyrighted images.

6. The system as recited in claim 1, further including the step of:
(e) printing the personalized product.

7. The system as recited in claim 6, further including the step of:
(f) mailing the personalized product to the consumer.

8. The system as recited in claim 1, further including the step of:
(e) providing a graphical user interface facilitating steps (a) and (b).
